(19) United States
(12) Patent Application Publication
(10) Pub. No.: US 2013/0100105 A1
(43) Pub. Date: Apr. 25, 2013

(54) SIGNAL GENERATOR CIRCUIT, LIQUID CRYSTAL DISPLAY DEVICE

(71) Applicants: Shige Furuta, Osaka-shi (JP); Makoto Yokoyama, Osaka-shi (JP); Yuhichiroh Murakami, Osaka-shi (JP); Yasushi Sasaki, Osaka-shi (JP)

(72) Inventors: Shige Furuta, Osaka-shi (JP); Makoto Yokoyama, Osaka-shi (JP); Yuhichiroh Murakami, Osaka-shi (JP); Yasushi Sasaki, Osaka-shi (JP)

(73) Assignee: Sharp Kabushiki Kaisha, Osaka-shi, Osaka (JP)

(21) Appl. No.: 13/806,878

(22) PCT Filed: Jun. 23, 2011
(86) PCT No.: PCT/JP2011/064472

§ 371 Date: Dec. 26, 2012

(30) Foreign Application Priority Data
Jun. 30, 2010 (JP) 2010-150282

(51) Int. Cl. G09G 3/36

(52) U.S. Cl. CPC G09G 3/3674
USPC 345/211; 345/87

(57) ABSTRACT

A signal generator circuit of the present invention is a signal generator circuit for use in a display device, the display device including (a) a pixel having a pixel electrode, (b) an electric conductor with which the pixel electrode forms a capacitor, (c) a data signal line driving circuit which outputs a data signal whose polarity is reversed for each n horizontal scanning period(s), where n is a natural number, and (d) a scanning signal line driving circuit which outputs scanning signals corresponding to respective stages, said signal generator circuit generating a drive signal supplied to the electric conductor, wherein: said signal generator circuit comprises flip flops corresponding to the respective stages, each flip flop including a gate circuit and a latch circuit; and in regard to one flip flop corresponding to one of the stages, (i) the gate circuit is supplied with a signal synchronized with a scanning signal corresponding to a preceding stage of the one of the stages, and a signal synchronized with a scanning signal corresponding to a subsequent stage of the one of the stages, (ii) the latch circuit is supplied with a polarity signal whose polarity is reversed for each n horizontal scanning period(s) via the gate circuit, and (iii) the drive signal of the one of the stages is generated in accordance with an output of the one flip flop. With the arrangement, it is possible to provide, with use of a simple configuration, a driver circuit for use in a liquid crystal display device which carries out CC (charge coupling) driving or COM driving.

### TECHNICAL FIELD

The present invention relates to a signal generator circuit (driver circuit) for use in, for example, a liquid crystal display device which carries out CC (charge coupling) driving (i.e., driving in which a potential of a pixel electrode is changed after data is written) or COM driving (i.e., driving in which a potential of a common electrode is changed before data is written).

### BACKGROUND ART

Patent Literature 1 discloses a conventional liquid crystal display device which carries out CC driving. According to the conventional liquid crystal display device, a potential of a pixel electrode is changed by (i) writing data (signal potential) to a pixel electrode, (ii) causing a corresponding scanning signal line to be non-active, and then (iii) reversing a potential polarity of a retention capacitor line (CS line) which forms a capacitor together with the pixel electrode. FIG. 32 illustrates respective configurations of a gate driver (scanning signal line driving circuit) 30 and a CS driver (retention capacitor line driving circuit) 40 both included in the liquid crystal display device.

### CITATION LIST

### Patent Literature 1

WO 2009/050926 (Publication Date: Apr. 23, 2009)

### SUMMARY OF INVENTION

### Technical Problem

There is, however, a problem that the CS driver illustrated in FIG. 32 has a complex configuration.

It is an object of the present invention to provide, with use of a simple configuration, a signal generator circuit (driver circuit) for use in, for example, a liquid crystal display device which carries out CC driving or COM driving.

### Solution to Problem

A signal generator circuit of the present invention is a signal generator circuit for use in a display device, the display device including (a) a pixel having a pixel electrode, (b) an electric conductor with which the pixel electrode forms a capacitor, (c) a data signal line driving circuit which outputs a data signal whose polarity is reversed for each n horizontal scanning period(s), where n is a natural number, and (d) a scanning signal line driving circuit which outputs scanning signals corresponding to respective stages, said signal generator circuit generating a drive signal supplied to the electric conductor, wherein: said signal generator circuit comprises flip flops corresponding to the respective stages, each flip flop including a gate circuit and a latch circuit; and in regard to one flip flop corresponding to one of the stages, (i) the gate circuit is supplied with a signal synchronized with a scanning signal corresponding to a preceding stage of the one of the stages, and a signal synchronized with a scanning signal corresponding to a subsequent stage of the one of the stages, (ii) the latch circuit is supplied with a polarity signal whose polarity is reversed for each n horizontal scanning period(s) via the gate circuit, and (iii) the drive signal of the one of the stages is generated in accordance with an output of the one flip flop.

As described above, in a case where a data signal has a polarity which is reversed for each n horizontal scanning period(s) (where n is a natural number), it is possible to, either before or after the data signal is written to a second pixel, change a potential of the electric conductor by supplying, to a gate circuit of a second flip flop, (i) a signal which is synchronized with a scanning signal for the first flip flop and (ii) a signal which is synchronized with a scanning signal for the third flip flop, and supplying, to a latch circuit of the second flip flop via the gate circuit, a polarity signal having a polarity which is reversed for each n horizontal scanning period(s). With the arrangement, it is possible to carry out CC driving or COM driving with use of a simple signal generator circuit.

### Advantageous Effects of Invention

According to the present invention, it is possible to carry out CC driving or COM driving with use of a signal generator circuit (driver circuit) having a simple configuration.

### BRIEF DESCRIPTION OF DRAWINGS

FIG. 1

FIG. 1 is a view schematically illustrating a configuration of a liquid crystal display device (Embodiment 1) including a CS driver of the present invention.

FIG. 2

FIG. 2 is a circuit diagram illustrating a configuration of the CS driver of the present invention.

FIG. 3

FIG. 3 is a circuit diagram illustrating a configuration of an inverter (output side) included in the CS driver of FIG. 2.

FIG. 4

FIG. 4 is a circuit diagram illustrating a configuration of a flip flop included in the CS driver of FIG. 2.

FIG. 5

FIG. 5 is a timing chart illustrating a method (forward direction scanning) for driving the liquid crystal display device including the CS driver of FIG. 2.

FIG. 6

FIG. 6 is a timing chart illustrating a method (inverse direction scanning) for driving the liquid crystal display device including the CS driver of FIG. 2.

FIG. 7

FIG. 7 is a circuit diagram illustrating another configuration of the CS driver of the present invention.

FIG. 8

FIG. 8 is a circuit diagram illustrating a configuration of a flip flop included in the CS driver of FIG. 7.

FIG. 9

FIG. 9 is a timing chart illustrating a method (forward direction scanning) for driving the liquid crystal display device including the CS driver of FIG. 7.

FIG. 10

FIG. 10 is a timing chart illustrating a method (inverse direction scanning) for driving the liquid crystal display device including the CS driver of FIG. 7.

FIG. 11

FIG. 11 is a timing chart illustrating an initialization operation of the liquid crystal display device including the CS driver of FIG. 7 (in which each flip flop is configured as illustrated in FIG. 8).

FIG. 12

FIG. 12 is a circuit diagram illustrating another configuration of the flip flop included in the CS driver of FIG. 7.

FIG. 13

FIG. 13 is a timing chart illustrating an initialization operation of the liquid crystal display device including the CS driver of FIG. 7 (in which each flip flop is configured as illustrated in FIG. 12).

FIG. 14

FIG. 14 is a circuit diagram illustrating still another configuration of the CS driver of the present invention.

FIG. 15

FIG. 15 is a circuit diagram illustrating a configuration of a flip flop included in the CS driver of FIG. 14.

FIG. 16

FIG. 16 is a circuit diagram illustrating another configuration of the flip flop included in the CS driver of FIG. 14.

FIG. 17

FIG. 17 is a timing chart illustrating a method for driving the liquid crystal display device including the CS driver of FIG. 14 (in which each flip flop is configured as illustrated in FIG. 16).

FIG. 18

FIG. 18 is a circuit diagram illustrating a variation of the flip flop of FIG. 16.

FIG. 19

FIG. 19 is a timing chart illustrating another method (in which polarity is reversed for each two horizontal scanning periods) for driving the liquid crystal display device including the CS driver of FIG. 7.

FIG. 20

FIG. 20 is a circuit diagram illustrating a configuration of a gate driver of a liquid crystal display device of the present invention.

FIG. 21

FIG. 21 is a circuit diagram illustrating a configuration of a flip flop included in the gate driver of FIG. 21.

FIG. 22

FIG. 22 is a timing chart illustrating a method (forward direction scanning) for driving the liquid crystal display device including the gate driver of FIG. 20.

FIG. 23

FIG. 23 is a timing chart illustrating a method (inverse direction scanning) for driving the liquid crystal display device including the gate driver of FIG. 20.

FIG. 24

FIG. 24 is a timing chart illustrating an initialization operation of the gate driver of FIG. 20.

FIG. 25

FIG. 25 is a view schematically illustrating a configuration of a liquid crystal display device (Embodiment 2) including a COM driver of the present invention.

FIG. 26

FIG. 26 is a circuit diagram illustrating a configuration of the COM driver of the present invention.

FIG. 27

FIG. 27 is a circuit diagram illustrating a configuration of a flip flop included in the COM driver of FIG. 26.

FIG. 28

FIG. 28 is a timing chart illustrating a method (forward direction scanning) for driving the liquid crystal display device including the COM driver of FIG. 26.

FIG. 29

FIG. 29 is a timing chart illustrating a method (inverse direction scanning) for driving the liquid crystal display device including the COM driver of FIG. 26.

FIG. 30

FIG. 30 is a circuit diagram illustrating an example configuration of an inverter.

FIG. 31

FIG. 31 is a view schematically illustrating a variation of the liquid crystal display device (Embodiment 1) of FIG. 1.

FIG. 32

FIG. 32 is a circuit diagram illustrating a configuration of a conventional CS driver.

### DESCRIPTION OF EMBODIMENTS

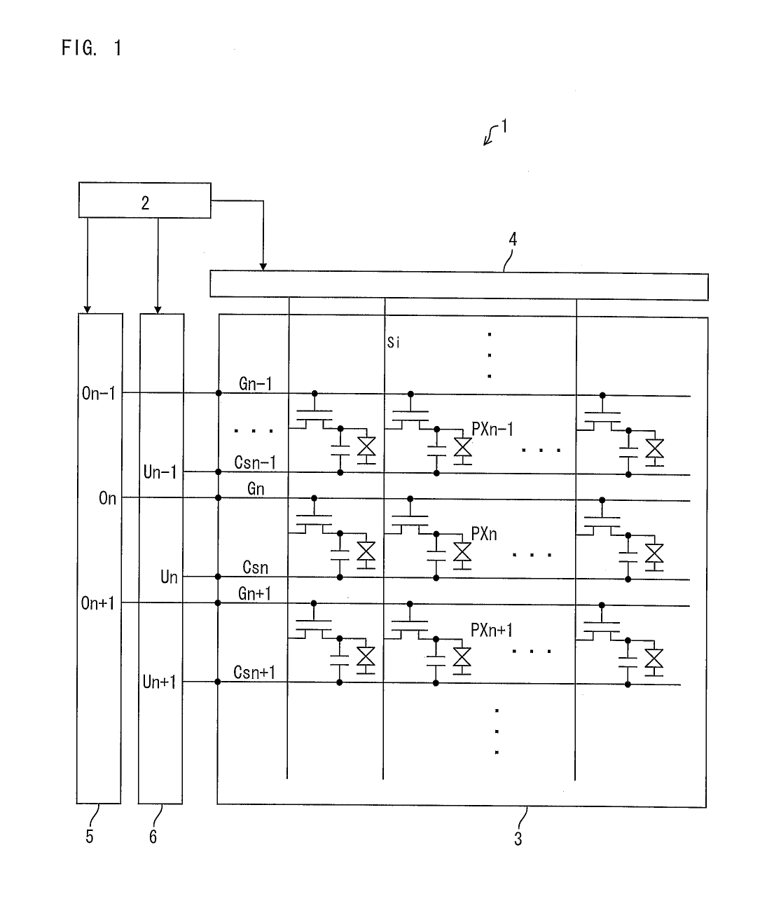

The following description will discuss Embodiments of the present invention with reference to FIGS. 1 through 31.

### Embodiment 1

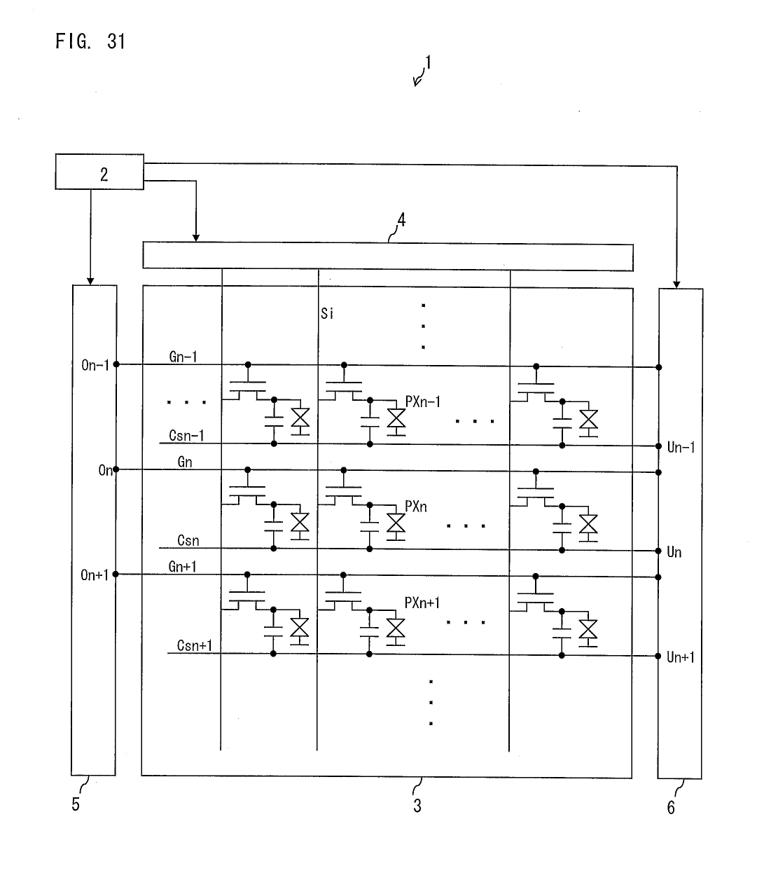

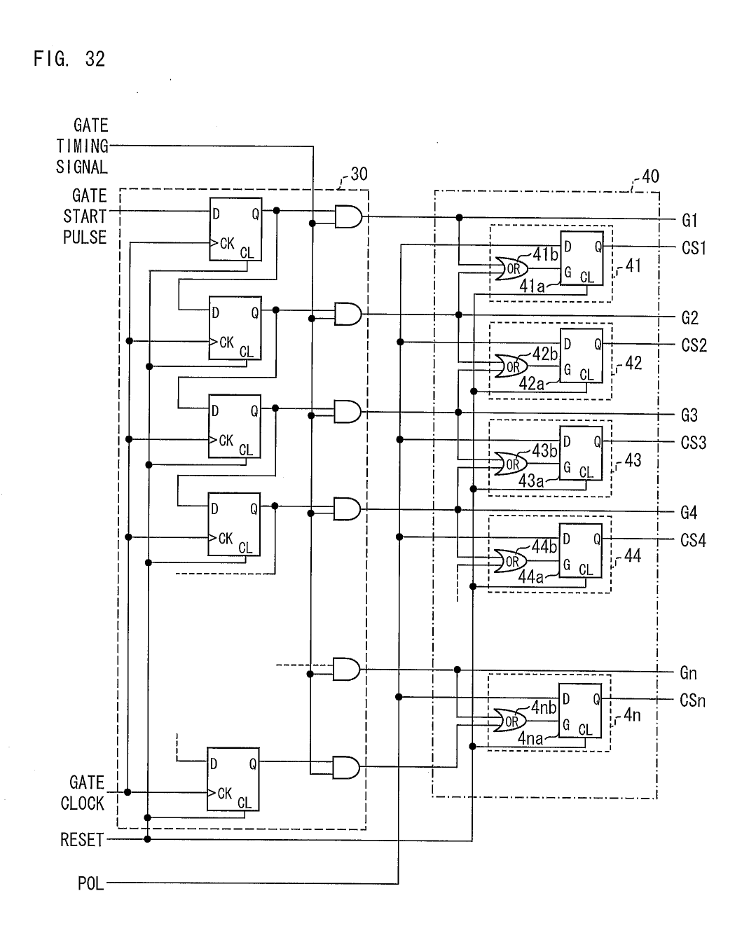

FIG. 1 is a block diagram illustrating a configuration of a liquid crystal display device 1 of Embodiment 1. As illustrated in FIG. 1, the liquid crystal display device 1 includes a display control circuit 2, a liquid crystal panel 3, a source driver 4, a gate driver 5, and a CS driver 6. The liquid crystal panel 3 includes scanning signal lines (Gn−1, Gn, Gn+1), data signal lines (Si), pixels (PXn−1, PXn, PXn+1), and retention capacitor lines (CSn−1, CSn, CSn+1). The pixel PXn, for example, includes a pixel electrode which is connected, via a TFT, to the scanning signal line Gn and the data signal line Si. The pixel electrode and the retention capacitor line CSn together form a capacitor. The retention capacitor line CSn is connected to an n-th output terminal Un of the CS driver 6. The scanning signal line Gn is connected to an n-th output terminal On of the gate driver 5. Note that, for example, the gate driver 5 (bidirectionally shiftable) outputs, from the n-th output terminal On, a scanning signal for driving an n-th scanning signal line. The source driver 4 for driving the data signal lines outputs data signals each of whose polarities is reversed for each n horizontal scanning period(s) (where n is a natural number). For example, the CS driver 6 outputs, from the n-th output terminal Un, a drive signal for driving an n-th retention capacitor line. The display control circuit 2 controls the source driver 4, the gate driver 5, and the CS driver 6. Note that the gate driver 5 and the CS driver 6 can be provided so that (i) they are disposed on one side of a display section (see FIG. 1) or (ii) the gate driver 5 is provided on one side of a display section (of the liquid crystal panel) and the CS driver 6 is provided on the other side of the display section (see FIG. 31) (i.e., so that the display section is provided between the gate driver 5 and the CS driver 6). The configuration of FIG. 31 allows for a narrow picture frame. Alternatively, at least one of the gate driver 5 and the CS driver 6 can be provided so as to be integral (monolithically) with the liquid crystal panel.

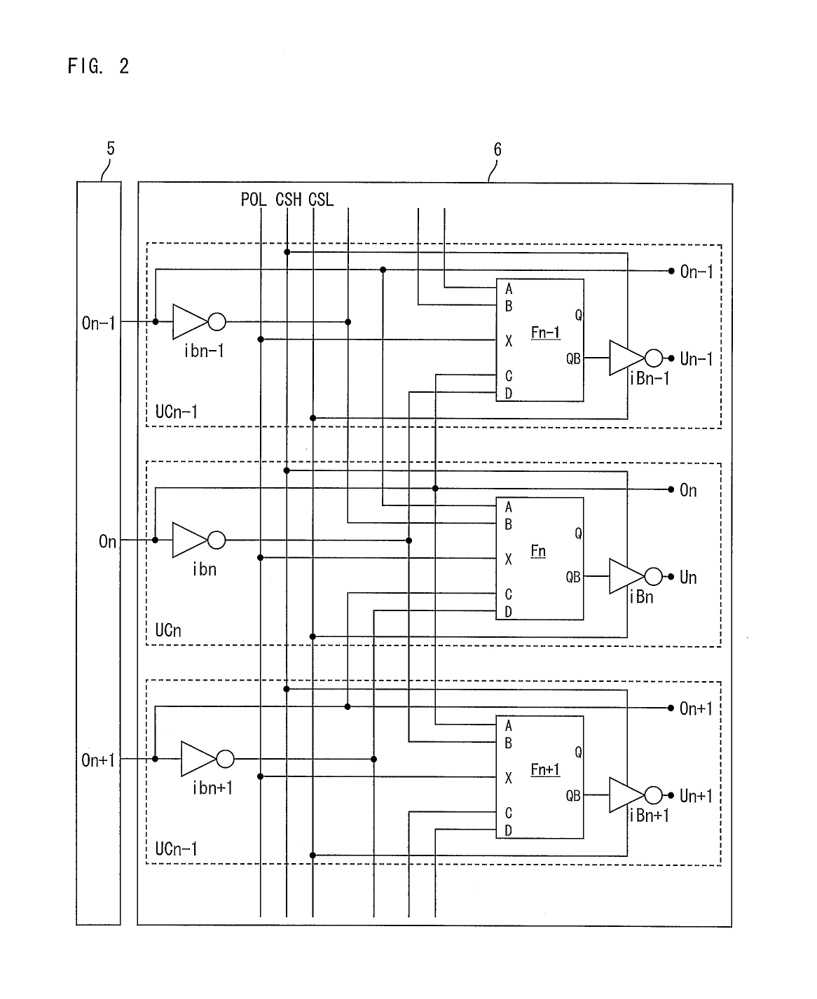

The CS driver 6 of FIG. 1 is configured as illustrated in FIG. 2. Specifically, the CS driver 6 includes a plurality of unit circuits (UCn−1, UCn, UCn+1). A CS polarity signal line POL is connected to the plurality of unit circuits (UCn−1, UCn, UCn+1). First and second CS electric potential supply lines CSH and CSL are connected to the plurality of unit circuits (UCn−1, UCn, UCn+1). The unit circuit UCn−1 is made up of a flip flop Fn−1 and two inverters ibn−1 and iBn−1, and has an output terminal Un−1. The unit circuit UCn is made up of a flip flop Fn and two inverters ibn and iBn, and has an output terminal Un. The unit circuit UCn+1 is made up of a flip flop Fn+1 and two inverters ibn+1 and iBn+1, and has an output terminal Un+1.

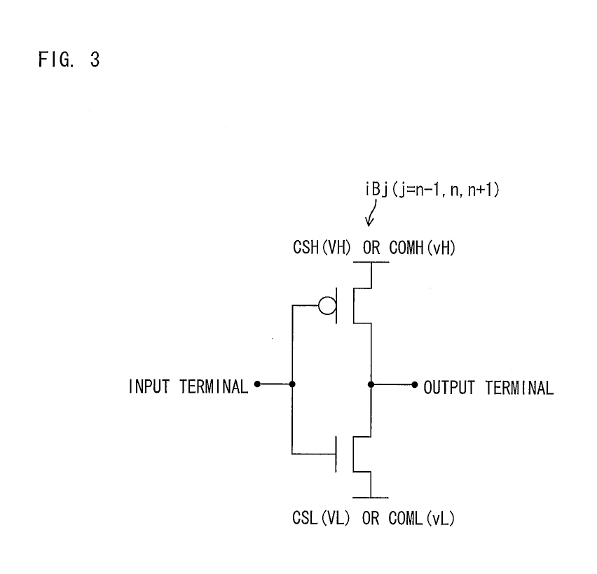

FIG. 3 illustrates how an inverter iBj (j=n−1, n, n+1) is specifically configured. As illustrated in FIG. 3, according to the inverter iBj, (i) (a) an input terminal is connected to a control terminal of a P channel transistor and a control terminal of an N channel transistor and (b) an output terminal is connected to one conducting terminal of the P channel transistor and one conducting terminal of the N channel transistor, and (ii) (a) the other conducting terminal of the P channel transistor is connected to the first CS electric potential (VH) supply line CSH and (b) the other conducting terminal of the N channel transistor is connected to the second CS electric potential (VL) supply line (Note that VH>VL).

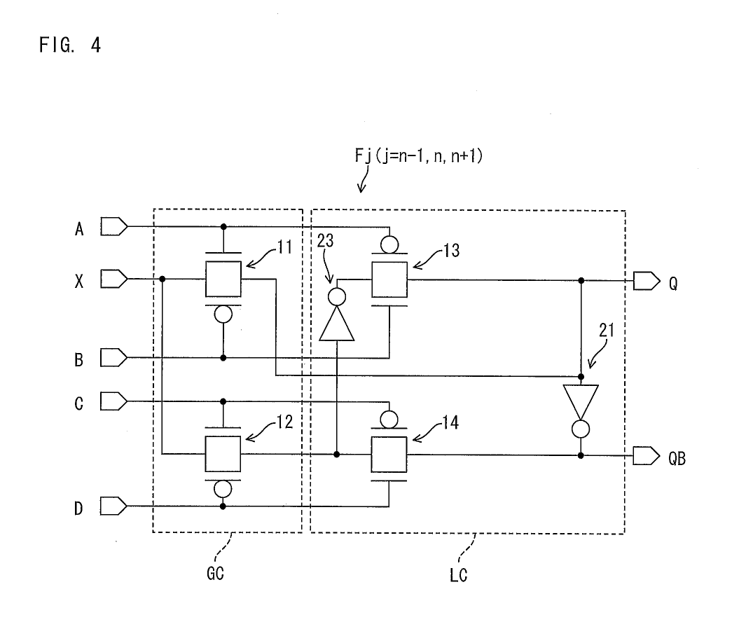

FIG. 4 illustrates how a flip flop Fj (j=n−1, n, n+1) is specifically configured. As illustrated in FIG. 4, the flip flop Fj has five input terminals (A through D, and X) and two output terminals (Q and QB). The flip flop Fj is made up of four analog switches 11 through 14 and two inverters 21 and 23. The terminal A is connected to an N terminal of the analog switch 11 and a P terminal of the analog switch 13. The terminal B is connected to a P terminal of the analog switch 11 and an N terminal of the analog switch 13. The terminal C is connected to an N terminal of the analog switch 12 and a P terminal of the analog switch 14. The terminal D is connected to a P terminal of the analog switch 12 and an N terminal of the analog switch 14. The terminal X is connected to an input terminal of the inverter 21 via the analog switch 11, and is further connected to an input terminal of the inverter 23 via the analog switch 12. The inverter 21 has an output terminal which is connected to the input terminal of the inverter 23 via the analog switch 14. The inverter 23 has an output terminal which is connected to the input terminal of the inverter 21 via the analog switch 13. The Q terminal is connected to the input terminal of the inverter 21. The terminal QB is connected to an output terminal of the inverter 21. The analog switches 11 and 12 constitute a gate circuit GC. The analog switches 13 and 14 and the inverters 21 and 23 constitute a latch circuit LC.

With reference to FIG. 2 again, the following description will discuss a j-th unit circuit UCj (j=n−1, n, n+1). An input terminal of the inverter ibj is connected to (i) a j-th output terminal Oj of the gate driver 5, (ii) the terminal C of a (j−1)th flip flop Fn−1 (preceding flip flop), and (iii) the terminal A of a (j+1)th flip flop Fn+1 (subsequent flip flop). An output terminal of the inverter circuit ibj is connected to (i) the terminal D of the (j−1)th flip flop Fn−1 and (ii) the terminal B of the (j+1)th flip flop Fn+1. The flip flop Fj is arranged such that the terminal A is connected to a (j−1)th output terminal Oj−1 of the gate driver, the terminal B is connected to an output terminal of the (j−1)th inverter ibj−1, the terminal C is connected to a (j+1)th output terminal Oj+1 of the gate driver, the terminal D is connected to an output terminal of the (j+l)th inverter ibj+1, the terminal X is connected to the CS polarity signal line POL, and the terminal QB is connected to an output terminal Uj of the unit circuit UCj via the j-th inverter iBj. With the unit circuit Ucj, (i) the electric potential VL (i.e., a low CS electric potential) is outputted from the output terminal Uj in a case where a high level (i.e., non-active) is outputted from the output terminal QB of the flip flop Fj and (ii) the electric potential VH (i.e., a high CS electric potential) is outputted from the output terminal Uj in a case where a low level (i.e., active) is outputted from the output terminal QB.

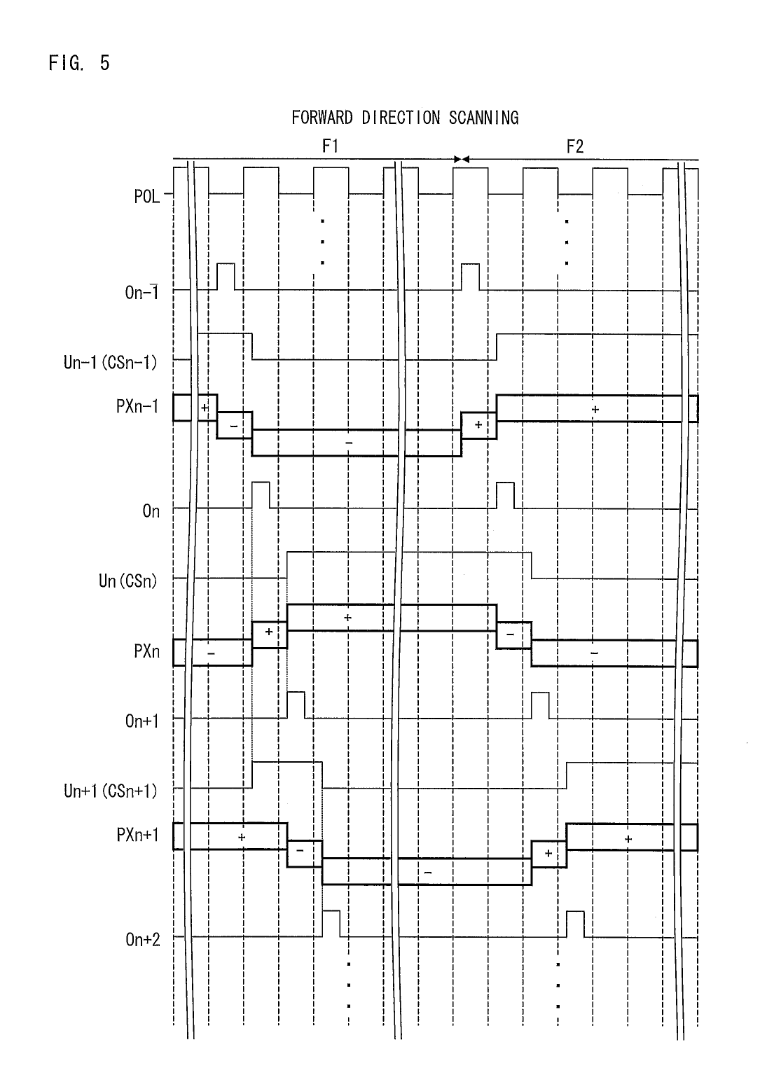

FIG. 5 is a timing chart illustrating a method (frames F1 and F2 during forward direction scanning) for driving the liquid crystal display device 1 including the CS driver 6 of FIG. 2. Note that a CS polarity signal, whose polarity is reversed for each horizontal scanning period (1H), is supplied to the CS polarity signal line POL. The frame F1 is a first frame which comes after the liquid crystal display device 1 is turned on. At the start of the frame F1, (i) the gate driver 5 is initialized so that each output terminal of the gate driver 5 becomes active and (ii) the CS driver 6 is also initialized so that the electric potential VL is outputted from each output terminal of the CS driver 6 (described later). Note that the following description will discuss operations while focusing on the n-th output terminal and the n-th unit circuit as respective references.

During the frame F1, in a case where an (n−1)th output terminal On−1 (preceding output terminal) of the gate driver 5 is changed into an active state, a signal potential having a negative polarity is written into a preceding pixel PXn−1. As a result, in the flip flop Fn, the terminal A is set to a high level, the terminal B is set to a low level, the terminal C is set to a low level, and the terminal D is set to a high level (i.e., only the analog switches 11 and 14 are each in an on-state). This causes an inverted signal (“H”) of the CS polarity signal (“L”) to be outputted from the output terminal QB. As such, an electric potential of the output terminal Un remains to be the electric potential VL (i.e., the low CS electric potential). In a case where the output terminal On−1 is then changed into a non-active state, in the flip flop Fn, the terminal A is set to a low level, the terminal B is set to a high level, the terminal C is set to the low level, and the terminal D is set to the high level (i.e., only the analog switches 13 and 14 are each in an on-state). This causes the flip flop Fn to be changed into a latch state (the high level is remained at the output terminal QB). The electric potential of the output terminal Un therefore remains to be the electric potential VL.

Next, in a case where the n-th output terminal On of the gate driver 5 is changed into an active state, a signal potential having a positive polarity is written into the pixel PXn. As a result, the flip flop Fn remains to be in the latch state. The electric potential of the output terminal Un therefore remains to be the electric potential VL. Note that, in the flip flop Fn+1, the terminal A is set to a high level, the terminal B is set to a low level, the terminal C is set to a low level, and the terminal D is set to a high level (i.e., only the analog switches 11 and 14 are each in an on-state). This causes an inverted signal (“L”) of the CS polarity signal (“H”) to be outputted from the output terminal QB. As such, an electric potential of the output terminal Un+1 is reversed into the electric potential VH (i.e., the high CS electric potential). In a case where the output terminal On is then changed into a non-active state, in the flip flop Fn+1, the terminal A is set to a low level, the terminal B is set to a high level, the terminal C is set to the low level, and the terminal D is set to the high level (i.e., only the analog switches 13 and 14 are each in an on-state). This causes the flip flop Fn to remain in the latch state (the low level is remained at the output terminal QB). The electric potential of the output terminal Un+1 therefore remains to be the electric potential VH.

Next, in a case where the next (n+1)th output terminal On+1 of the gate driver 5 is changed into an active state, a signal potential having a negative polarity is written into the pixel PXn+1. As a result, in the flip flop Fn, the terminal A is set to the low level, the terminal B is set to the high level, the terminal C is set to the high level, and the terminal D is set to the low level (i.e., only the analog switches 12 and 13 are each in an on-state). This causes the CS polarity signal (“L”) to be outputted from the output terminal QB. As such, the electric potential of the output terminal Un is reversed into the electric potential VH (i.e., the high CS electric potential). Consequently, the electric potential of the pixel PXn is shifted toward an electric potential higher than a written signal potential (positive). In a case where the output terminal On+1 is then changed into a non-active state, in the flip flop Fn, the terminal A is set to the low level, the terminal B is set to the high level, the terminal C is set to the low level, and the terminal D is set to the high level (i.e., only the analog switches 13 and 14 are each in an on-state). This causes the flip flop Fn to remain in the latch state (the low level is remained at the output terminal QB). The electric potential of the output terminal Un therefore remains to be the electric potential VH. It follows that the pixel PXn remains to have the potential as shifted.

Next, in a case where the (n+2)th output terminal On+2 of the gate driver 5 is changed into an active state, in the flip flop Fn+1, the terminal A is set to the low level, the terminal B is set to the high level, the terminal C is set to the high level, and the terminal D is set to the low level (i.e., only the analog switches 12 and 13 are each in an on-state). This causes the CS polarity signal (“H”) to be outputted from the output terminal QB. As such, the electric potential of the output terminal Un+1 is reversed into the electric potential VL (i.e., the low CS electric potential). Consequently, the electric potential of the pixel PXn+1 is shifted toward an electric potential lower than a written signal potential (negative). In a case where the output terminal On+2 is then changed into a non-active state, in the flip flop Fn+1, the terminal A is set to the low level, the terminal B is set to the high level, the terminal C is set to the low level, and the terminal D is set to the high level (i.e., only the analog switches 13 and 14 are each in an on-state). This causes the flip flop Fn to remain in the latch state (the high level is remained at the output terminal QB). The electric potential of the output terminal Un+1 therefore remains to be the electric potential VL. It follows that the pixel PXn+1 remains to have the potential as shifted.

During the frame F2, in a case where the (n−1)th output terminal On−1 (preceding output terminal) of the gate driver 5 is changed into the active state, a signal potential having a positive polarity is written into the preceding pixel PXn−1. As a result, in the flip flop Fn, the terminal A is set to the high level, the terminal B is set to the low level, the terminal C is set to the low level, and the terminal D is set to the high level (i.e., only the analog switches 11 and 14 are each in an on-state). This causes an inverted signal (“L”) of the CS polarity signal (“H”) to be outputted from the output terminal QB. As such, the electric potential of the output terminal Un remains to be the electric potential VH (i.e., the high CS electric potential). In a case where the output terminal On−1 is then changed into a non-active state, in the flip flop Fn, the terminal A is set to the low level, the terminal B is set to the high level, the terminal C is set to the low level, and the terminal D is set to the high level (i.e., only the analog switches 13 and 14 are each in an on-state). This causes the flip flop Fn to be changed into the latch state (the low level is remained at the output terminal QB). The electric potential of the output terminal Un therefore remains to be the electric potential VH.

Next, in a case where the n-th output terminal On of the gate driver 5 is changed into an active state, a signal potential having a negative polarity is written into the pixel PXn. As a result, the flip flop Fn remains to be in the latch state. The electric potential of the output terminal Un therefore remains to be the electric potential VH. Note that, in the flip flop Fn+1, the terminal A is set to the high level, the terminal B is set to the low level, the terminal C is set to the low level, and the terminal D is set to the high level (i.e., only the analog switches 11 and 14 are each in an on-state). This causes an inverted signal (“H”) of the CS polarity signal (“L”) to be outputted from the output terminal QB. As such, the electric potential of the output terminal Un+1 remains to be the electric potential VL (i.e., the low CS electric potential). In a case where the output terminal On is then changed into a non-active state, in the flip flop Fn+1, the terminal A is set to the low level, the terminal B is set to the high level, the terminal C is set to the low level, and the terminal D is set to the high level (i.e., only the analog switches 13 and 14 are each in an on-state). This causes the flip flop Fn to remain in the latch state (the high level is remained at the output terminal QB). The electric potential of the output terminal Un+1 therefore remains to be the electric potential VL.

Next, in a case where the next (n+1)th output terminal On+1 of the gate driver 5 is changed into an active state, a signal potential having a positive polarity is written into the pixel PXn+1. As a result, in the flip flop Fn, the terminal A is set to the low level, the terminal B is set to the high level, the terminal C is set to the high level, and the terminal D is set to the low level (i.e., only the analog switches 12 and 13 are each in an on-state). This causes the CS polarity signal (“H”) to be outputted from the output terminal QB. As such, the electric potential of the output terminal Un is reversed into the electric potential VL (i.e., the low CS electric potential). Consequently, the electric potential of the pixel PXn is shifted toward an electric potential lower than a written signal potential (negative). In a case where the output terminal On+1 is then changed into a non-active state, in the flip flop Fn, the terminal A is set to the low level, the terminal B is set to the high level, the terminal C is set to the low level, and the terminal D is set to the high level (i.e., only the analog switches 13 and 14 are each in an on-state). This causes the flip flop Fn to remain in the latch state (the high level is remained at the output terminal QB). The electric potential of the output terminal Un therefore remains to be the electric potential VL. It follows that the pixel PXn remains to have the potential as shifted.

Next, in a case where the (n+2)th output terminal On+2 of the gate driver 5 is changed into an active state, in the flip flop Fn+1, the terminal A is set to the low level, the terminal B is set to the high level, the terminal C is set to the high level, and the terminal D is set to the low level (i.e., only the analog switches 12 and 13 are each in an on-state). This causes the CS polarity signal (“L”) to be outputted from the output terminal QB. As such, the electric potential of the output terminal Un+1 is reversed into the electric potential VH (i.e., the high CS electric potential). Consequently, the electric potential of the pixel PXn+1 is shifted toward an electric potential higher than a written signal potential (positive). In a case where the output terminal On+2 is then changed into a non-active state, in the flip flop Fn+1, the terminal A is set to the low level, the terminal B is set to the high level, the terminal C is set to the low level, and the terminal D is set to the high level (i.e., only the analog switches 13 and 14 are each in an on-state). This causes the flip flop Fn to remain in the latch state (the low level is remained at the output terminal QB). The electric potential of the output terminal Un+1 therefore remains to be the electric potential VH. It follows that the pixel PXn+1 remains to have the potential as shifted.

A flip flop of the CS driver 6 (see FIG. 2) thus latches (i) an inverted signal of a CS polarity signal generated when a preceding output terminal (i.e., an immediately preceding output terminal) of the gate driver 5 is changed into an active state and then (ii) a CS polarity signal generated when a next output terminal (i.e., an immediately subsequent output terminal) of the gate driver 5 is changed into an active state. Since the CS polarity signal is subjected to 1H polarity reversal, the polarity of an inverted signal of a CS polarity signal generated when the preceding output terminal of the gate driver 5 is changed into an active state is reversed to the polarity of a CS polarity signal generated when the subsequent output terminal is changed into an active state. As such, the polarities of electric potentials of a retention capacitor line, which are generated before and after writing of a signal potential into a pixel, are reversed to each other. Note that the retention capacitor line and a pixel electrode of a pixel form a capacitor. It is therefore possible to carry out CC driving with a simple circuit configuration as illustrated in FIG. 2. By carrying out latching operations twice, it is possible to reverse the polarities of the electric potentials of the retention capacitor line which are generated before and after the writing of the signal potential into the pixel, regardless of the electric potential (H or L) of the retention capacitor line generated before the first one of the latching operations (twice). As such, almost no screen irregularity is observed even during a first frame which comes after the liquid crystal display device 1 is turned on. Note that, at the start of the first frame, the CS driver is initialized so that an electric potential of each output terminal of the CS driver is set to a second CS electric potential (VL). According to the timing chart of FIG. 5, a source polarity signal to be supplied to the source driver 4 has a phase which is identical to a phase of the CS polarity signal to be supplied to the CS polarity signal line POL. It is therefore possible to use a single polarity signal both as the source polarity signal and the CS polarity signal.

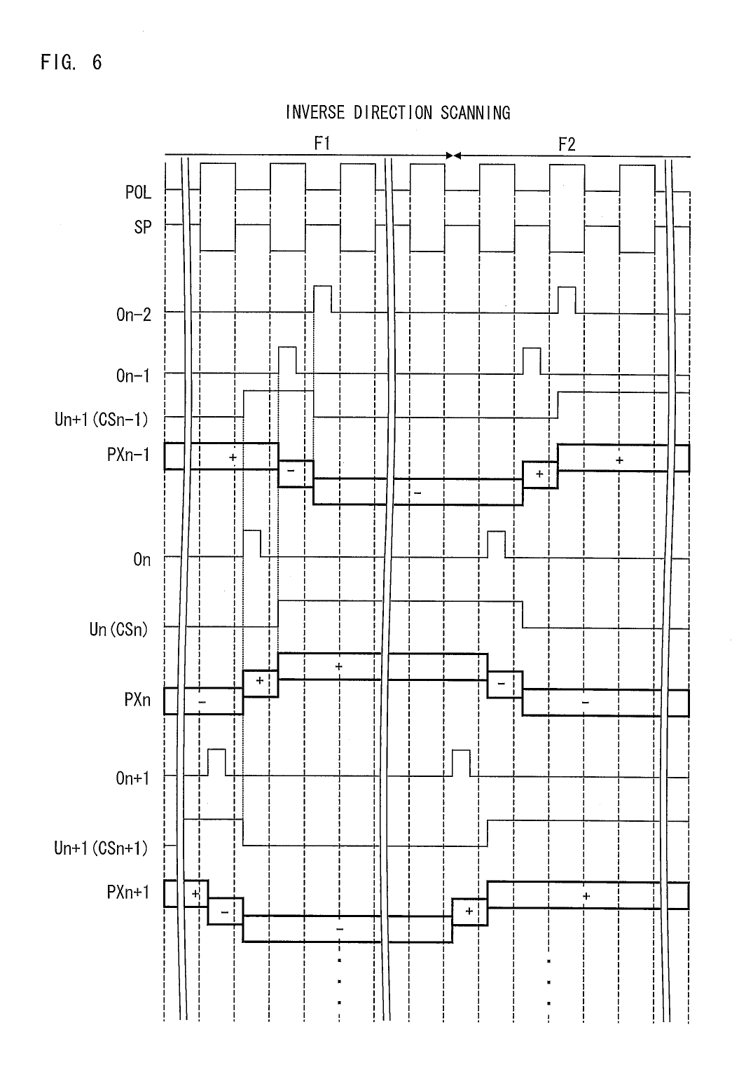

Note that the liquid crystal display device 1 including the CS driver 6 of FIG. 2 carries out inverse direction scanning as illustrated in FIG. 6. In this case, a CS polarity signal supplied to the CS polarity signal line POL simply needs to have a phase which is opposite to a phase of a source polarity signal SP supplied to the source driver 4.

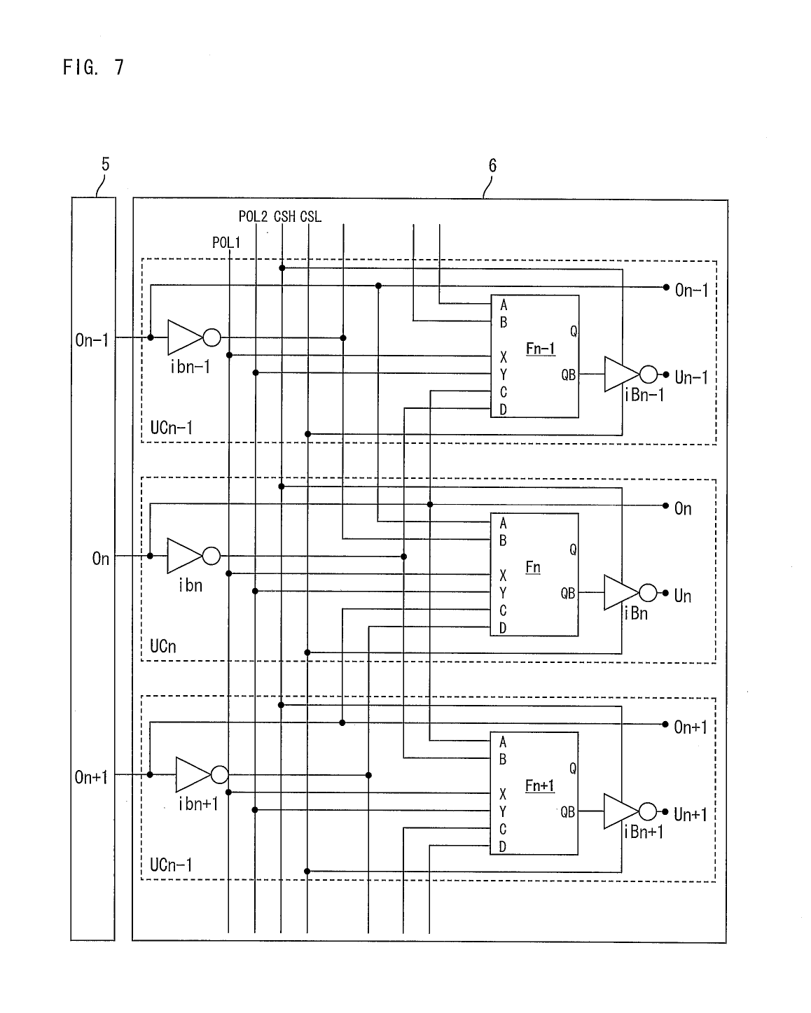

The CS driver 6 is alternatively configured as illustrated in FIG. 7. The CS driver 6 of FIG. 7 includes: a plurality of unit circuits (UCn−1, UCn, UCn+1). First and second CS polarity signal lines POL1 and POL2 are connected to the plurality of unit circuits (UCn−1, UCn, UCn+1). First and second CS electric potential supply lines CSH and CSL are connected to the plurality of unit circuits (UCn−1, UCn, UCn+1). The unit circuit UCn−1 is made up of a flip flop Fn−1 and two inverters ibn−1 and iBn−1, and has an output terminal Un−1. The unit circuit UCn is made up of a flip flop Fn and two inverters ibn and iBn, and has an output terminal Un. The unit circuit UCn+1 is made up of a flip flop Fn+1 and two inverters ibn+1 and iBn+1, and has an output terminal Un+1.

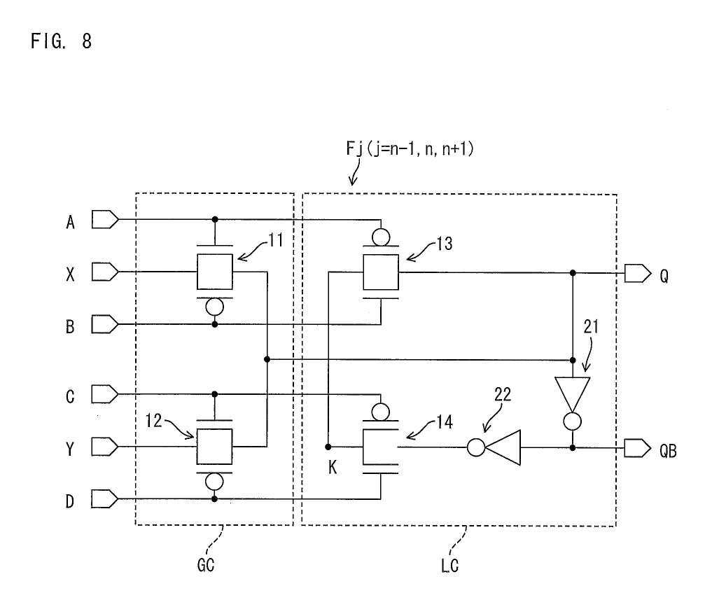

FIG. 8 illustrates how a flip flop Fj (j=n−1, n, n+1) of FIG. 7 is specifically configured. As illustrated in FIG. 8, the flip flop Fj has six input terminals (A through D, X, and Y) and two output terminals (Q and QB). The flip flop Fj is made up of four analog switches 11 through 14 and two inverters 21 and 22. The terminal A is connected to an N terminal of the analog switch 11 and a P terminal of the analog switch 13. The terminal B is connected to a P terminal of the analog switch 11 and an N terminal of the analog switch 13. The terminal C is connected to an N terminal of the analog switch 12 and a P terminal of the analog switch 14. The terminal D is connected to a P terminal of the analog switch 12 and an N terminal of the analog switch 14. The terminal X is connected to an input terminal of the inverter 21 via the analog switch 11. The terminal Y is connected to the input terminal of the inverter 21 via the analog switch 12. The inverter 21 has an output terminal which is connected to an input terminal of the inverter 22. The inverter 22 has an output terminal which is connected to a node K via the analog switch 14. The node K is connected to the input terminal of the inverter 21 via the analog switch 13. The Q terminal is connected to the input terminal of the inverter 21. The terminal QB is connected to the output terminal of the inverter 21. The analog switches 11 and 12 constitute a gate circuit GC. The analog switches 13 and 14 and the inverters 21 and 22 constitute a latch circuit LC.

With reference to FIG. 7 again, the following description will discuss a j-th unit circuit UCj (j=n−1, n, n+1). An input terminal of the inverter ibj is connected to (i) a j-th output terminal Oj of the gate driver 5, (ii) the terminal C of a (j−1)th flip flop Fn−1 (preceding flip flop), and (iii) the terminal A of a (j+1)th flip flop Fn+1 (subsequent flip flop). An output terminal of the inverter circuit ibj is connected to (i) the terminal D of the (j−1)th flip flop Fn−1 and (ii) the terminal B of the (j+1)th flip flop Fn+1. The flip flop Fj is arranged such that the terminal A is connected to a (j−1)th output terminal Oj−1 of the gate driver, the terminal B is connected to an output terminal of the (j-1)th inverter ibj−1, the terminal C is connected to a (j+1)th output terminal Oj+1 of the gate driver, the terminal D is connected to an output terminal of the (j+1)th inverter ibj+1, the terminal X is connected to the first CS polarity signal line POL1, the terminal Y is connected to the second CS polarity signal line POL2, and the terminal QB is connected to an output terminal Uj of the unit circuit UCj via the j-th inverter iBj. With the unit circuit Ucj, (i) the electric potential VL (i.e., a low CS electric potential) is outputted from the output terminal Uj in a case where a high level (i.e., non-active) is outputted from the output terminal QB of the flip flop Fj and (ii) the electric potential VH (i.e., a high CS electric potential) is outputted from the output terminal Uj in a case where a low level (i.e., active) is outputted from the output terminal QB.

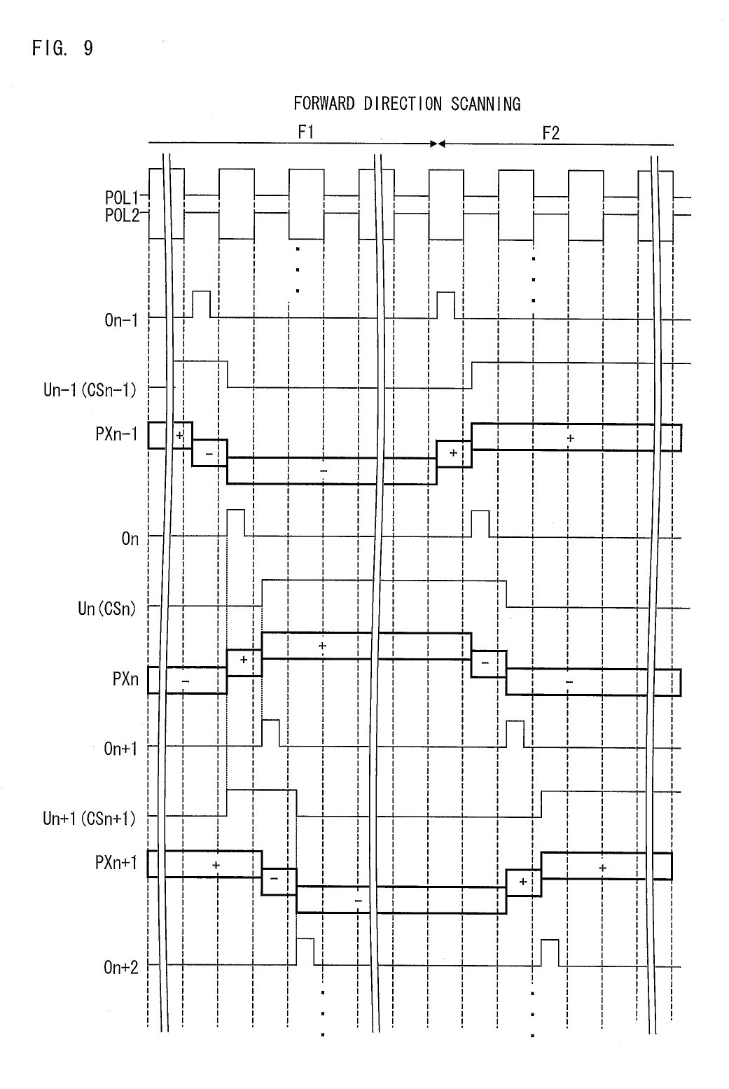

FIG. 9 is a timing chart illustrating a method (frames F1 and F2) for driving the liquid crystal display device 1 including the CS driver 6 of FIG. 7. Note that a first CS polarity signal, whose polarity is reversed for each horizontal scanning period (1H), is supplied as the first CS polarity signal line POL1 and a second CS polarity signal, which is an inverted signal of the first CS polarity signal, is supplied to the second CS polarity signal line POL2. At the start of the frame F1, (i) the gate driver 5 is initialized so that each output terminal of the gate driver 5 becomes active and (ii) the CS driver 6 is also initialized so that the electric potential VL is outputted from each output terminal of the CS driver 6 (the initializations are described later). Note that the following description will discuss operations while focusing on the n-th output terminal and the n-th unit circuit as respective references.

During the frame F1, in a case where an (n−1)th output terminal On−1 (preceding output terminal) of the gate driver 5 is changed into an active state, in the flip flop Fn, the terminal A is set to a high level, the terminal B is set to a low level, the terminal C is set to a low level, and the terminal D is set to a high level (i.e., only the analog switches 11 and 14 are each in an on-state). This causes an inverted signal (“H”) of the CS polarity signal (“L”) to be outputted from the output terminal QB. As such, an electric potential of the output terminal Un remains to be the electric potential VL (i.e., the low CS electric potential). In a case where the output terminal On−1 is then changed into a non-active state, in the flip flop Fn, the terminal A is set to a low level, the terminal B is set to a high level, the terminal C is set to the low level, and the terminal D is set to the high level (i.e., only the analog switches 13 and 14 are each in an on-state). This causes the flip flop Fn to be changed into a latch state (the high level is remained at the output terminal QB). The electric potential of the output terminal Un therefore remains to be the electric potential VL.

Next, in a case where an n-th output terminal On of the gate driver 5 is changed into an active state, a signal potential having a positive polarity is written into the pixel PXn. As a result, the flip flop Fn remains to be in the latch state. The electric potential of the output terminal Un therefore remains to be the electric potential VL. Note that, in the flip flop Fn+1, the terminal A is set to a high level, the terminal B is set to a low level, the terminal C is set to a low level, and the terminal D is set to a high level (i.e., only the analog switches 11 and 14 are each in an on-state). This causes an inverted signal (“L”) of the first CS polarity signal (“H”) to be outputted from the output terminal QB. As such, an electric potential of the output terminal Un+1 is reversed into the electric potential VH (i.e., the high CS electric potential). In a case where the output terminal On is then changed into a non-active state, in the flip flop Fn+1, the terminal A is set to a low level, the terminal B is set to a high level, the terminal C is set to the low level, and the terminal D is set to the high level (i.e., only the analog switches 13 and 14 are each in an on-state). This causes the flip flop Fn to remain in the latch state (the low level is remained at the output terminal QB). The electric potential of the output terminal Un+1 therefore remains to be the electric potential VH.

Next, in a case where the next (n+1)th output terminal On+1 of the gate driver 5 is changed into an active state, a signal potential having a negative polarity is written into the pixel PXn+1. As a result, in the flip flop Fn, the terminal A is set to a low level, the terminal B is set to a high level, the terminal C is set to a high level, and the terminal D is set to a low level (i.e., only the analog switches 12 and 13 are each in an on-state). This causes an inverted signal (“L”) of the second CS polarity signal (“H”) to be outputted from the output terminal QB. As such, an electric potential of the output terminal Un is reversed into the electric potential VH (i.e., the high CS electric potential). Consequently, the electric potential of the pixel PXn is shifted toward an electric potential higher than a written signal potential (positive). In a case where the output terminal On+1 is then changed into a non-active state, in the flip flop Fn, the terminal A is set to a low level, the terminal B is set to a high level, the terminal C is set to the low level, and the terminal D is set to the high level (i.e., only the analog switches 13 and 14 are each in an on-state). This causes the flip flop Fn to remain in the latch state (the low level is remained at the output terminal QB). The electric potential of the output terminal Un therefore remains to be the electric potential VH. It follows that the pixel PXn remains to have the potential as shifted.

Next, in a case where the (n+2)th output terminal On+2 of the gate driver 5 is changed into an active state, in the flip flop Fn+1, the terminal A is set to the low level, the terminal B is set to the high level, the terminal C is set to a high level, and the terminal D is set to a low level (i.e., only the analog switches 12 and 13 are each in an on-state). This causes an inverted signal (“H”) of the second CS polarity signal (“L”) to be outputted from the output terminal QB. As such, the electric potential of the output terminal Un+1 is reversed into the electric potential VL (i.e., the low CS electric potential). Consequently, the electric potential of the pixel PXn+1 is shifted toward an electric potential lower than a written signal potential (negative). In a case where the output terminal On+2 is then changed into a non-active state, in the flip flop Fn+1, the terminal A is set to the low level, the terminal B is set to the high level, the terminal C is set to the low level, and the terminal D is set to the high level (i.e., only the analog switches 13 and 14 are each in an on-state). This causes the flip flop Fn to remain in the latch state (the high level is remained at the output terminal QB). The electric potential of the output terminal Un+1 therefore remains to be the electric potential VL. It follows that the pixel PXn+1 remains to have the potential as shifted.

During the frame F2, in a case where the (n−1)th output terminal On−1 (preceding output terminal) of the gate driver 5 is changed into the active state, in the flip flop Fn, the terminal A is set to the high level, the terminal B is set to the low level, the terminal C is set to the low level, and the terminal D is set to the high level (i.e., only the analog switches 11 and 14 are each in the on-state). This causes an inverted signal (“L”) of the first CS polarity signal (“H”) to be outputted from the output terminal QB. As such, the electric potential of the output terminal Un remains to be the electric potential VH (i.e., the high CS electric potential). In a case where the output terminal On−1 is then changed into a non-active state, in the flip flop Fn, the terminal A is set to the low level, the terminal B is set to the high level, the terminal C is set to the low level, and the terminal D is set to the high level (i.e., only the analog switches 13 and 14 are each in an on-state). This causes the flip flop Fn to be changed into the latch state (the low level is remained at the output terminal QB). The electric potential of the output terminal Un therefore remains to be the electric potential VH.

Next, in a case where the n-th output terminal On of the gate driver 5 is changed into an active state, a signal potential having a negative polarity is written into the pixel PXn. As a result, the flip flop Fn remains to be in the latch state. The electric potential of the output terminal Un therefore remains to be the electric potential VH. Note that, in the flip flop Fn+1, the terminal A is set to the high level, the terminal B is set to the low level, the terminal C is set to the low level, and the terminal D is set to the high level (i.e., only the analog switches 11 and 14 are each in an on-state). This causes an inverted signal (“H”) of the first CS polarity signal (“L”) to be outputted from the output terminal QB. As such, the electric potential of the output terminal Un+1 remains to be the electric potential VL (i.e., the low CS electric potential). In a case where the output terminal On is then changed into a non-active state, in the flip flop Fn+1, the terminal A is set to the low level, the terminal B is set to the high level, the terminal C is set to the low level, and the terminal D is set to the high level (i.e., only the analog switches 13 and 14 are each in an on-state). This causes the flip flop Fn to remain in the latch state (the high level is remained at the output terminal QB). The electric potential of the output terminal Un+1 therefore remains to be the electric potential VL.

Next, in a case where the next (n+1)th output terminal On+1 of the gate driver 5 is changed into an active state, a signal potential having a positive polarity is written into the pixel PXn+1. As a result, in the flip flop Fn, the terminal A is set to a low level, the terminal B is set to a high level, the terminal C is set to a high level, and the terminal D is set to a low level (i.e., only the analog switches 12 and 13 are each in an on-state). This causes an inverted signal (“H”) of the second CS polarity signal (“L”) to be outputted from the output terminal QB. As such, an electric potential of the output terminal Un is reversed into the electric potential VL (i.e., the low CS electric potential). Consequently, the electric potential of the pixel PXn is shifted toward an electric potential lower than a written signal potential (negative). In a case where the output terminal On+1 is then changed into a non-active state, in the flip flop Fn, the terminal A is set to the low level, the terminal B is set to the high level, the terminal C is set to the low level, and the terminal D is set to the high level (i.e., only the analog switches 13 and 14 are each in an on-state). This causes the flip flop Fn to remain in the latch state (the high level is remained at the output terminal QB). The electric potential of the output terminal Un therefore remains to be the electric potential VL. It follows that the pixel PXn remains to have the potential as shifted.

Next, in a case where the (n+2)th output terminal On+2 of the gate driver 5 is changed into an active state, in the flip flop Fn+1, the terminal A is set to the low level, the terminal B is set to the high level, the terminal C is set to the high level, and the terminal D is set to the low level (i.e., only the analog switches 12 and 13 are each in an on-state). This causes an inverted signal (“L”) of the second CS polarity signal to be outputted from the output terminal QB. As such, the electric potential of the output terminal Un+1 is reversed into the electric potential VH (i.e., the high CS electric potential). Consequently, the electric potential of the pixel PXn+1 is shifted toward an electric potential higher than a written signal potential (positive). In a case where the output terminal On+2 is then changed into a non-active state, in the flip flop Fn+1, the terminal A is set to the low level, the terminal B is set to the high level, the terminal C is set to the low level, and the terminal D is set to the high level (i.e., only the analog switches 13 and 14 are each in an on-state). This causes the flip flop Fn to remain in the latch state (the low level is remained at the output terminal QB). The electric potential of the output terminal Un+1 therefore remains to be the electric potential VH. It follows that the pixel PXn+1 remains to have the potential as shifted.

A flip flop of the CS driver 6 (see FIG. 7) thus latches (i) an inverted signal of a first CS polarity signal generated when a preceding output terminal (i.e., an immediately preceding output terminal) of the gate driver 5 is changed into an active state and then (ii) an inverted signal of a second CS polarity signal generated when a next output terminal (i.e., an immediately subsequent output terminal) of the gate driver 5 is changed into an active state. Since the first and second CS polarity signals are subjected to 1H polarity reversal and have respective phases which are opposite to each other, the polarity of an inverted signal of a CS polarity signal generated when the preceding output terminal of the gate driver 5 is changed into an active state is reversed to the polarity of a CS polarity signal generated when the subsequent output terminal is changed into an active state. As such, the polarities of electric potentials of a retention capacitor line, which are generated before and after writing of a signal potential into a pixel, are reversed to each other. Note that the retention capacitor line and a pixel electrode of a pixel form a capacitor. It is therefore possible to carry out CC driving with a simple circuit configuration as illustrated in FIG. 7. By carrying out latching operations twice, it is possible to reverse the polarities of the electric potentials of the retention capacitor line which are generated before and after the writing of the signal potential into the pixel, regardless of the electric potential (H or L) of the retention capacitor line generated before the first one of the latching operations (twice). As such, almost no screen irregularity is observed even during a first frame which comes after the liquid crystal display device 1 is turned on. Note that, at the start of the first frame, the CS driver is initialized so that an electric potential of each output terminal of the CS driver is set to a second CS electric potential (VL). According to the timing chart of FIG. 9, a source polarity signal to be supplied to the source driver 4 has a phase which is identical to a phase of the first CS polarity signal to be supplied to the CS polarity signal line POLL It is therefore possible to use a single polarity signal both as the source polarity signal and the CS polarity signal.

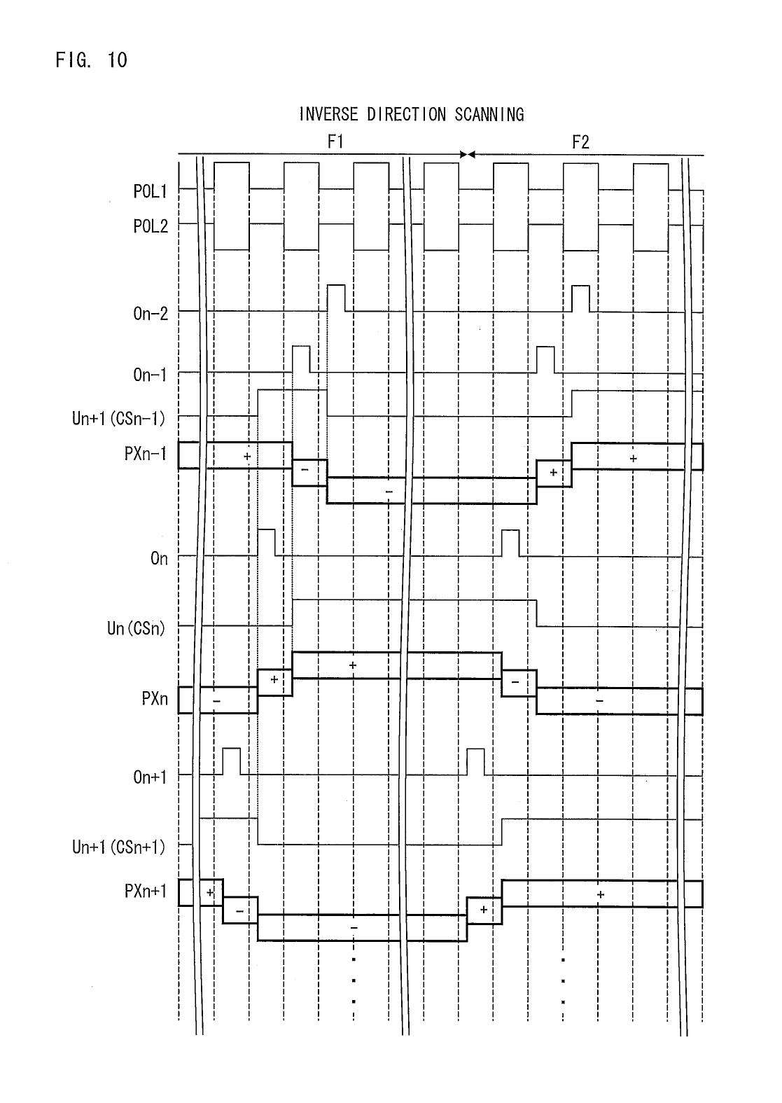

Note that the liquid crystal display device 1 including the CS driver 6 of FIG. 7 carries out inverse direction scanning as illustrated in FIG. 10. In this case, since the source polarity signal to be supplied to the source driver 4 has a phase which is identical to a phase of the second CS polarity signal to be supplied to the second CS polarity signal line POL2, it is also possible to use a single polarity signal which serves as both the source polarity signal and the second CS polarity signal.

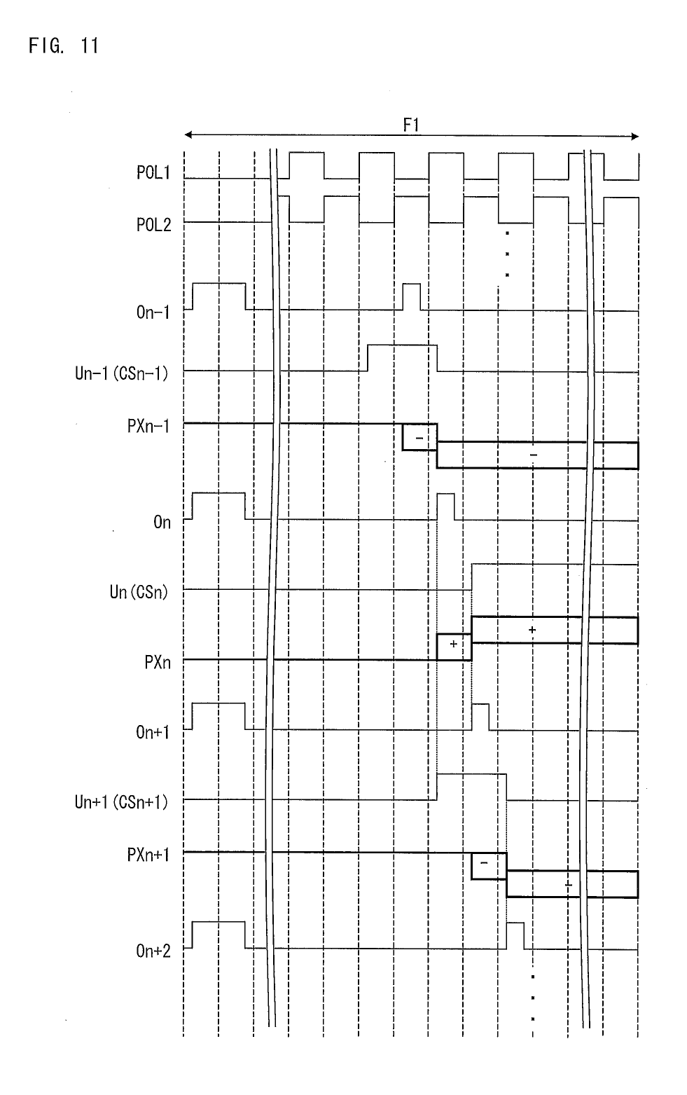

FIG. 11 is a timing chart illustrating an initialization operation of the CS driver 6 of FIG. 7, which initialization operation is carried out during a first frame which comes after the liquid crystal display device 1 is turned on. As illustrated in FIG. 11, each output terminal of the gate driver 5 is set to an active state (“H”) during the initialization (described later). It is therefore possible to fix, at VL, each of the output terminals of the CS driver 6, provided that the first and second CS polarity signals are fixed at identical phases (“L”). Note that a high-level signal (“H”) is supplied, during the initialization, to the terminals X and Y of the flip flop of FIG. 8 . This causes (i) only the analog switches 11 and 12 to be in an on-state and (ii) the output terminal QB to be set to “H”. The output terminal QB remains to be “H” even when (i) the analog switches 11 and 12 become an off state and (ii) the analog switches 13 and 14 become an on state, in response to completion of the initialization.

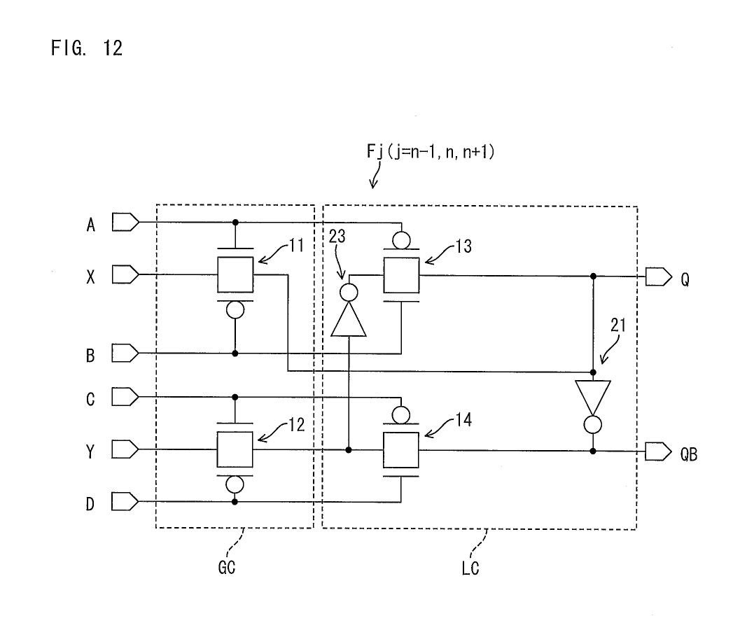

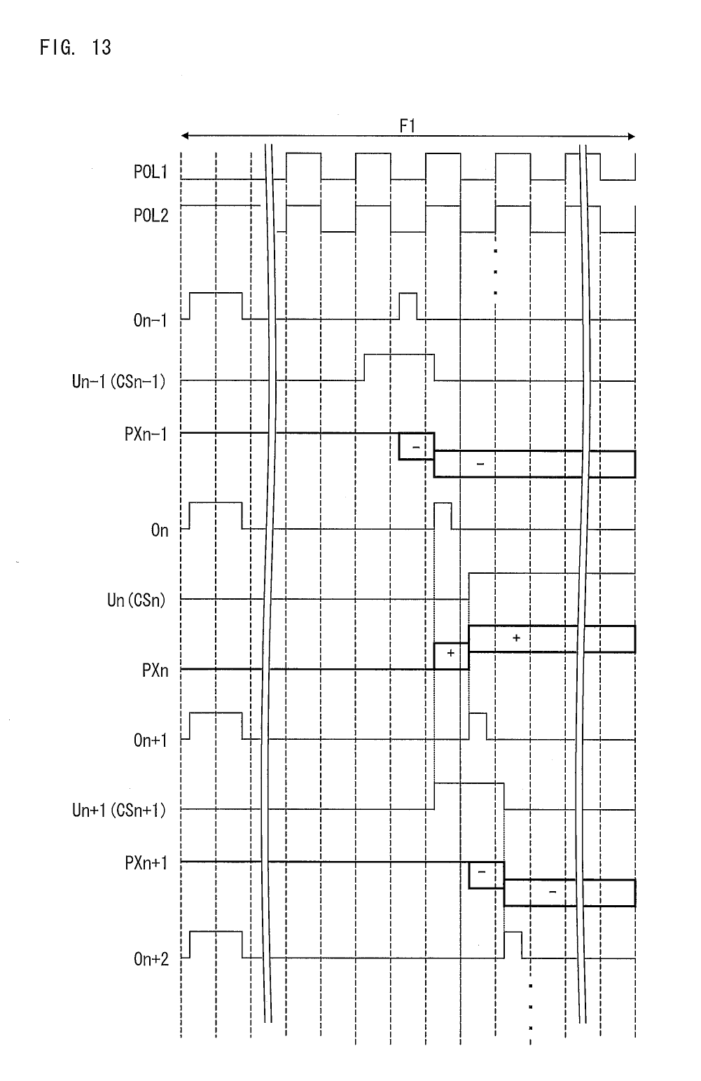

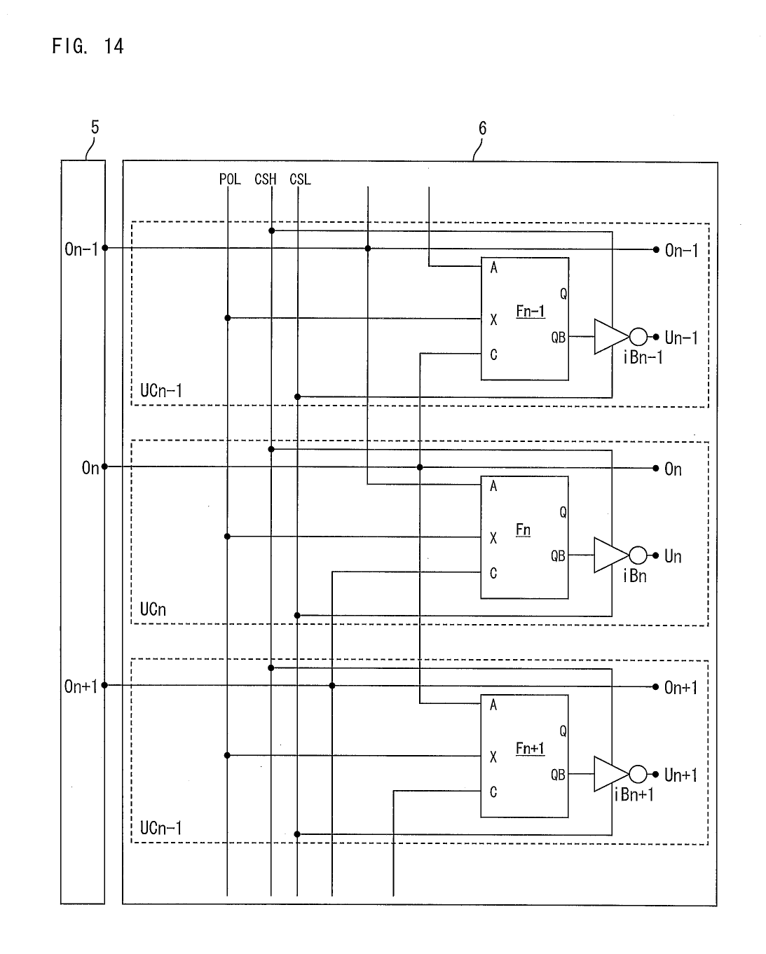

In a case where a flip flop of FIG. 4 is employed as each of the flip flops in the CS driver 6 of FIG. 2, the output terminal QB may not remain to be “H” (i.e., the output terminal QB may not be fixed) due to through current generated in the flip flop when the initialization is completed, even if a low-level signal is supplied to the terminal X of the flip flop of FIG. 4 (i.e., only the analog switches 11 and 12 are set to an on-state) during the initialization so that the output terminal QB is set to “H.” In view of the circumstances, the CS driver 6 can have an alternative configuration (see FIG. 7) in which (i) a terminal Y is further provided in the flip flop of FIG. 4 (see FIG. 12) and (ii) the first and second CS polarity signals are supplied to the terminals X and Y, respectively. In this case, (i) during the initialization, the phases of the first and second CS polarity signals are fixed to be opposite to each other (i.e., the first CS polarity signal is fixed at “L” and the second CS polarity signal is fixed at “H”) and (ii) after the initialization, the phases of the first and second CS polarity signals are fixed to be identical to each other (see FIG. 13). This allows each of the output terminals of the CS driver to be fixed at VL during the initialization. Note that low-level and high-level signals are supplied to the terminals X and Y of the flip flop of FIG. 12, respectively, during the initialization so that (i) only the analog switches 11 and 12 are each in an on-state and (ii) the output terminal QB is set to “H”. The output terminal QB remains to be “H” even when (i) the analog switches 11 and 12 become an off state and (ii) the analog switches 13 and 14 become an on state, in response to completion of the initialization. FIG. 14 illustrates a configuration of a further CS driver 6.

The CS driver 6 of FIG. 14 includes: a plurality of unit circuits (UCn−1, UCn, UCn+1). A CS polarity signal line POL is connected to the plurality of unit circuits (UCn−1, UCn, UCn+1). First and second CS electric potential supply lines CSH and CSL are connected to the plurality of unit circuits (UCn−1, UCn, UCn+1). The unit circuit UCn−1 is made up of a flip flop Fn−1 and two inverters ibn−1 and iBn−1, and has an output terminal Un−1. The unit circuit UCn is made up of a flip flop Fn and two inverters ibn and iBn, and has an output terminal Un. The unit circuit UCn+1 is made up of a flip flop Fn+1 and two inverters ibn+1 and iBn+1, and has an output terminal Un+1.

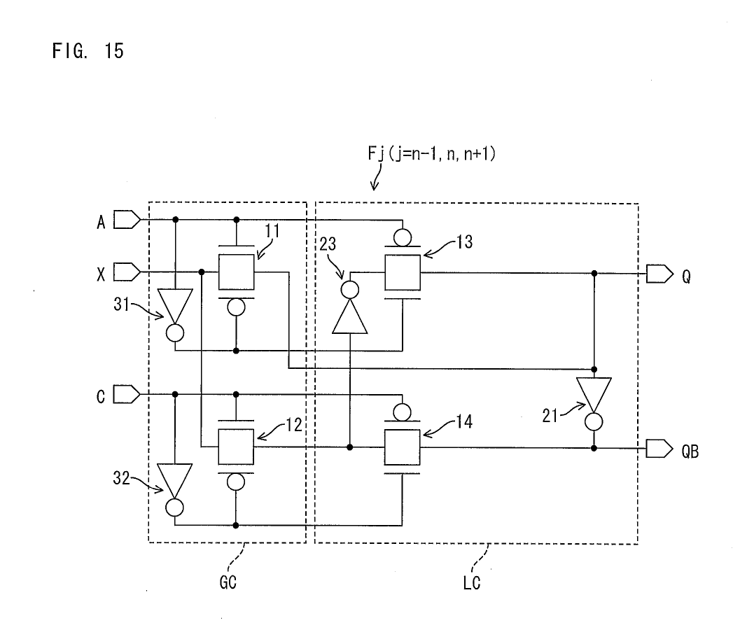

FIG. 15 illustrates how a flip flop Fj (j=n−1, n, n+1) is specifically configured. As illustrated in FIG. 15, the flip flop Fj has three input terminals (A, C, and X) and two output terminals (Q and QB). The flip flop Fj is made up of four analog switches 11 through 14 and four inverters 21, 23, 31, and 32. The terminal A is connected to (i) an N terminal of the analog switch 11, (ii) a P terminal of the analog switch 13, and an input terminal of the inverter 31. The inverter 31 has an output terminal which is connected to a P terminal of the analog switch 11 and an N terminal of the analog switch 13. The terminal C is connected to (i) an N terminal of the analog switch 12, (ii) a P terminal of the analog switch 14, and (iii) an input terminal of the inverter 32. The inverter 32 has an output terminal which is connected to a P terminal of the analog switch 12 and an N terminal of the analog switch 14. The terminal X is connected to an input terminal of the inverter 21 via the analog switch 11, and is further connected to an input terminal of the inverter 23 via the analog switch 12. The inverter 21 has an output terminal which is connected to the input terminal of the inverter 23 via the analog switch 14. The inverter 23 has an output terminal which is connected to the input terminal of the inverter 21 via the analog switch 13. The Q terminal is connected to the input terminal of the inverter 21. The terminal QB is connected to the output terminal of the inverter 21. The analog switches 11 and 12 and the inverters 31 and 32 constitute a gate circuit GC. The analog switches 13 and 14 and the inverters 21 and 23 constitute a latch circuit LC.

With reference to FIG. 14 again, the following description will discuss a j-th unit circuit UCj (j=n−1, n, n+1). A j-th output terminal Oj of the gate driver 5 is connected to (i) the terminal C of a (j−1)th flip flop Fn−1 (preceding flip flop) and (ii) the terminal A of a (j+1)th flip flop Fn+1 (subsequent flip flop). The flip flop Fj is arranged such that the terminal A is connected to a (j−1)th output terminal Oj−1 of the gate driver, the terminal C is connected to a (j+1)th output terminal Oj+1 of the gate driver, the terminal X is connected to the CS polarity signal line POL, and the terminal QB is connected to an output terminal Uj of the unit circuit UCj via the j-th inverter iBj. With the unit circuit Ucj, (i) the electric potential VL (i.e., a low CS electric potential) is outputted from the output terminal Uj in a case where a high level (i.e., non-active) is outputted from the output terminal QB of the flip flop Fj and (ii) the electric potential VH (i.e., a high CS electric potential) is outputted from the output terminal Uj in a case where a low level (i.e., active) is outputted from the output terminal QB.

Note that FIGS. 5 and 6 illustrate how a method for driving the liquid crystal display device 1 including the CS driver 6 of FIG. 14 is carried out. With the configuration of FIG. 14, it is possible to reduce the number of wires in the CS driver.

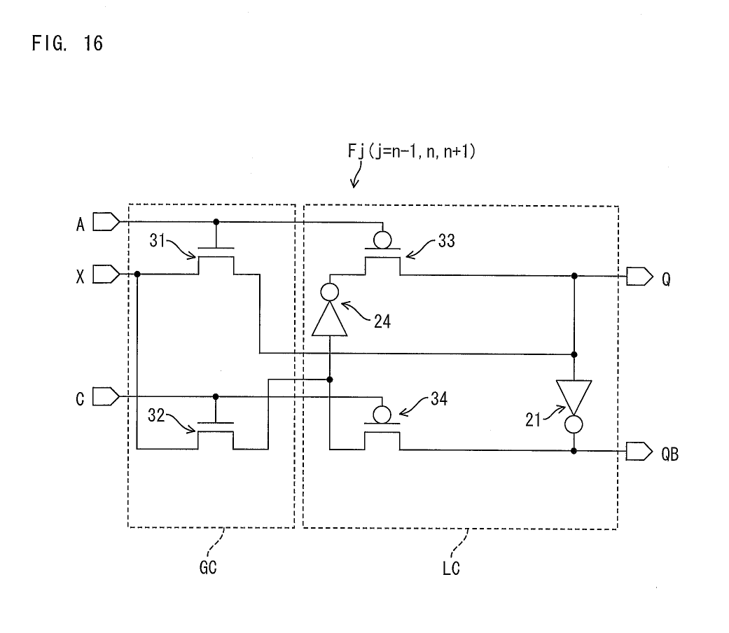

Each flip flop included in the CS driver 6 of FIG. 14 can be configured as illustrated in FIG. 16. The flip flop Fj (j=n−1, n, n+1) of FIG. 16 has three input terminals (A, C, and X) two output terminals (Q and QB). The flip flop Fj is made up of two P channel transistors 33 and 34, two N channel transistors 31 and 32, and two inverters 21 and 24. The terminal A is connected to a gate terminal of the N channel transistor 31 and a gate terminal of the P channel transistor 33. The terminal C is connected to a gate terminal of the N channel transistor 32 and a gate terminal of the P channel transistor 34. The terminal X is connected to an input terminal of the inverter 21 via the N channel transistor 31, and is further connected to an input terminal of the inverter 24 via the N channel transistor 32. The inverter 21 has an output terminal which is connected to the input terminal of the inverter 24 via the P channel transistor 34. The inverter 24 has an output terminal which is connected to the input terminal of the inverter 21 via the P channel transistor 33. The Q terminal is connected to the input terminal of the inverter 21. The terminal QB is connected to the output terminal of the inverter 21. The N channel transistors 31 and 32 constitute a gate circuit GC. The P channel transistors 33 and 34 and the inverters 21 and 24 constitute a latch circuit LC.

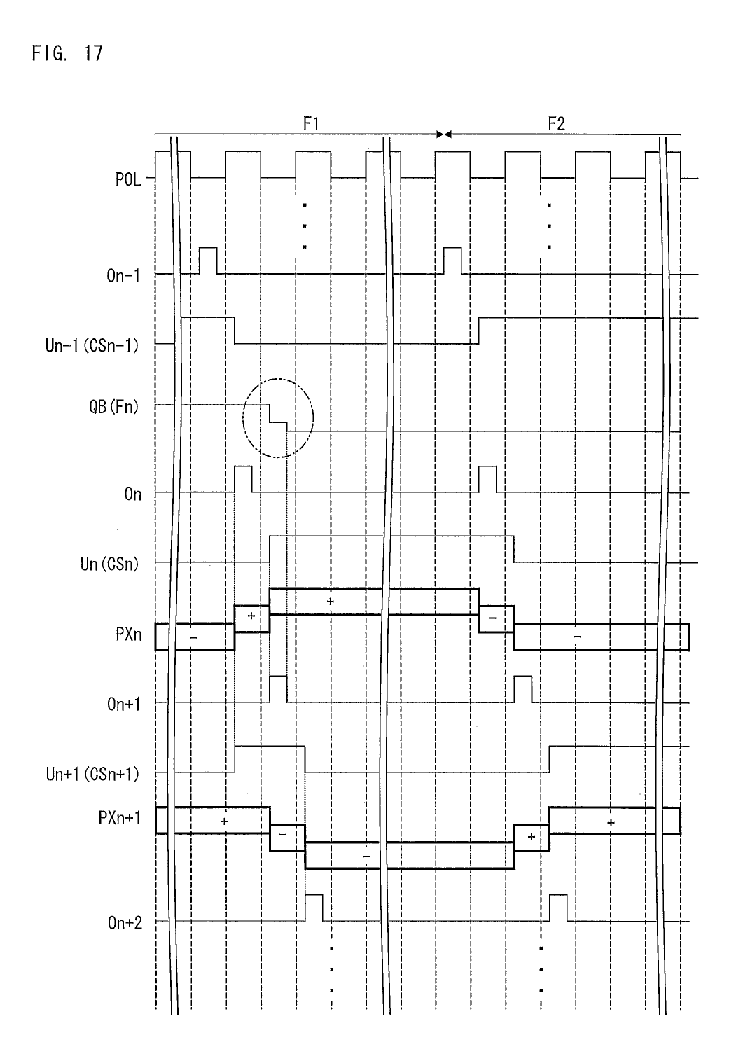

According to the CS driver 6 of FIG. 14 which includes the flip flop of FIG. 16, for example, the output terminal QB of the flip flop Fn has an electric potential which falls when the output terminal On+1 of the gate driver 5 is changed into an active state, but does not fall to “L” (threshold shift). Such an electric potential ultimately falls to “L” when the flip flop Fn receives feedback in response to the output terminal On+1 of the gate driver 5 being changed into a non-active state (see FIG. 17). The number of elements can be reduced by employing the configuration of FIG. 16, in a case where, for example, (i) a gate pulse has a sufficiently large amplitude or (ii) no problem is caused even in a case where a threshold shift occurs in an output of a flip flop.

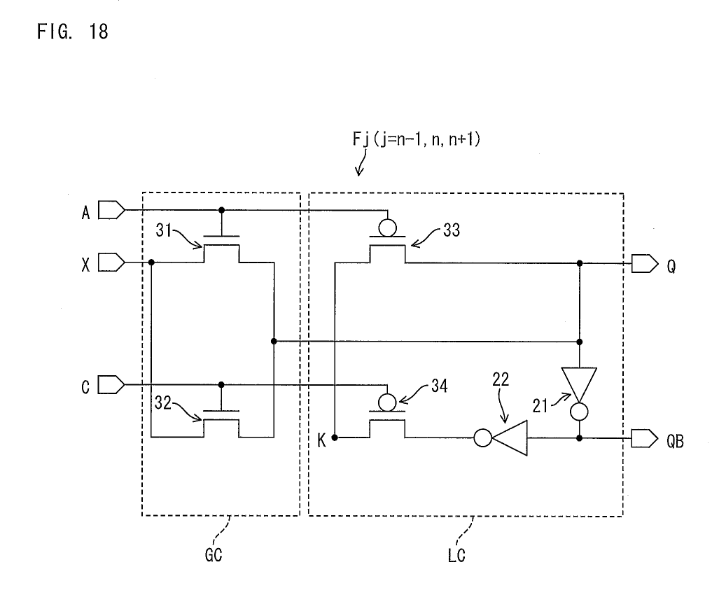

The flip flop of FIG. 16 can alternatively be configured as illustrated in FIG. 18. The flip flop Fj (j=n−1, n, n+1) of FIG. 18 has three input terminals (A, C, and X) and two output terminals (Q and QB). The flip flop Fj is made up of two P channel transistors 33 and 34, two N channel transistors 31 and 32, and two inverters 21 and 22. The terminal A is connected to a gate terminal of the N channel transistor 31 and a gate terminal of the P channel transistor 33. The terminal C is connected to a gate terminal of the N channel transistor 32 and a gate terminal of the P channel transistor 34. The terminal X is connected to an input terminal of the inverter 21 via the N channel transistor 31, and is further connected to the input terminal of the inverter 21 via the N channel transistor 32. The inverter 21 has an output terminal which is connected to an input terminal of the inverter 22. The inverter 22 has an output terminal which is connected to a node K via the P channel transistor 34. The node K is connected to the input terminal of the inverter 21 via the P channel transistor 33. The Q terminal is connected to the input terminal of the inverter 21. The terminal QB is connected to the output terminal of the inverter 21. The N channel transistors 31 and 32 constitute a gate circuit GC. The P channel transistors 33 and 34 and the inverters 21 and 22 constitute a latch circuit LC.

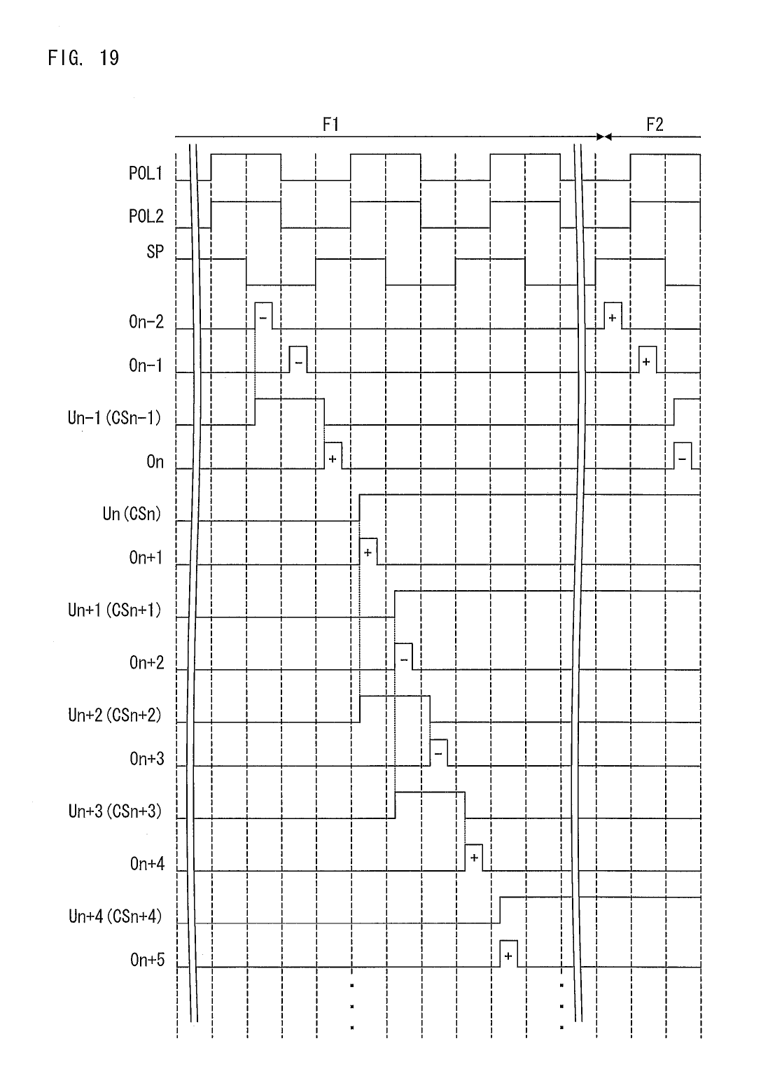

According to the CS driver, (i) the CS polarity signal (or the first and second CS polarity signals) is subjected to 1H polarity reversal and (ii) writing of a signal potential into a pixel is subjected to 1 line reversal driving. The present embodiment is, however, not limited to such. The CS driver 6 of FIG. 7 (in which each flip flop is configured, for example, as illustrated in FIG. 8) can alternatively be driven as illustrated in FIG. 19. Specifically, (i) the first and second CS polarity signals (i.e., signals POL1 and POL2) are each subjected to 2H polarity reversal and (ii) writing of a signal potential into a pixel is subjected to 2-line reversal driving (i.e., driving in which a polarity of a writing electric potential is reversed for each two lines) while the first and second CS polarity signals have identical phases. In this case, it is simply necessary that (i) a source polarity signal SP to be supplied to the source driver 4 be subjected to 2H polarity reversal and (ii) the first and second CS polarity signals to be supplied to the first and second CS polarity signal lines POL1 and POL2, respectively, each have phase lead of, for example, 1H with respect to a phase of the source polarity signal SP.

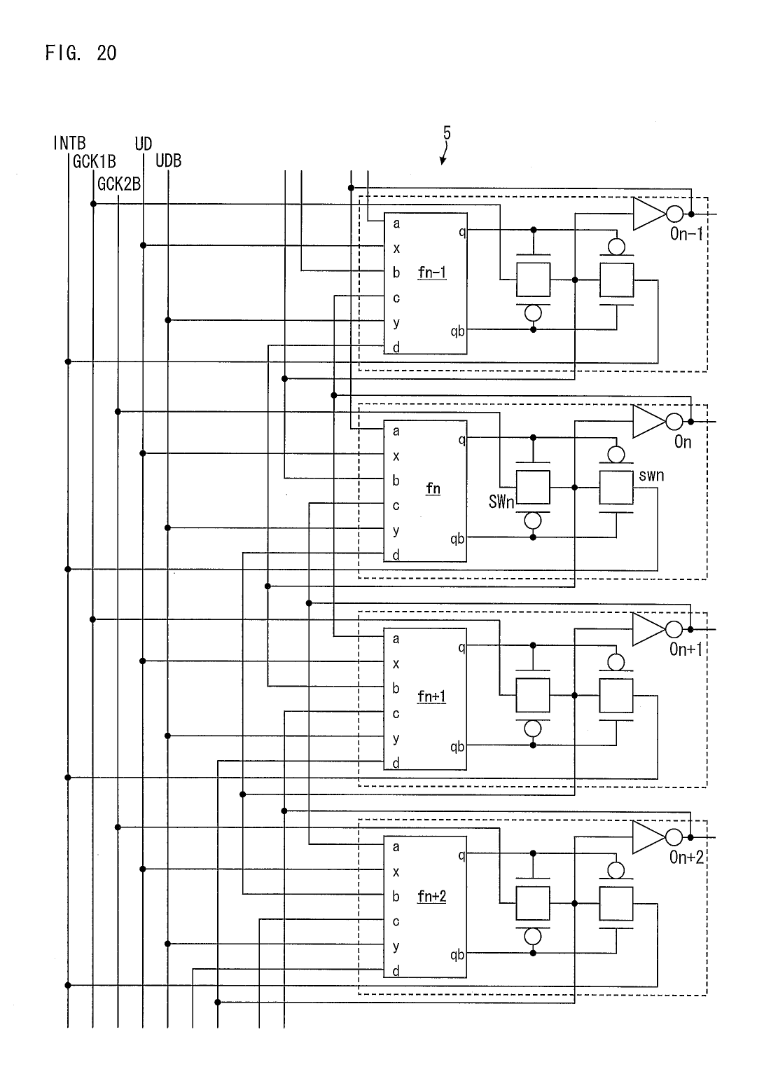

FIG. 20 is a circuit diagram illustrating a circuit configuration of the gate driver 5 of FIG. 1. As illustrated in FIG. 20, the gate driver has an INTB (inversion initialization signal) line, a GCK1B (first inversion gate clock, sync signal) line, a GCK2B (second inversion gate clock, sync signal) line, a UD (shift direction signal 1) line, and a UDB2 (shift direction signal 2) line. The gate driver includes a shift register made up of first through last unit circuits.

Note that (i) GCK1B and GCK2B are clock signals whose active periods (low-level periods) do not overlap each other, (ii) INITB is a signal which is at a low level (active) during an initialization period and which is at a high level during a period other than the initialization period, and (iii) UD1 is a signal which is at a high level during a forward direction shift and which is at a low level during an inverse direction shift, whereas UD2 is a signal which is at a low level during a forward direction shift and which is at a high level during an inverse direction shift.

An n-th (where n is an integer of 1 to m) shift register, for example, includes a flip flop fn, two analog switches SWn and swn, and an inverter. The n-th shift register has an output terminal On.

The flip flop fn has input terminals a, x, b, c, y, and d and output terminals q and qb.

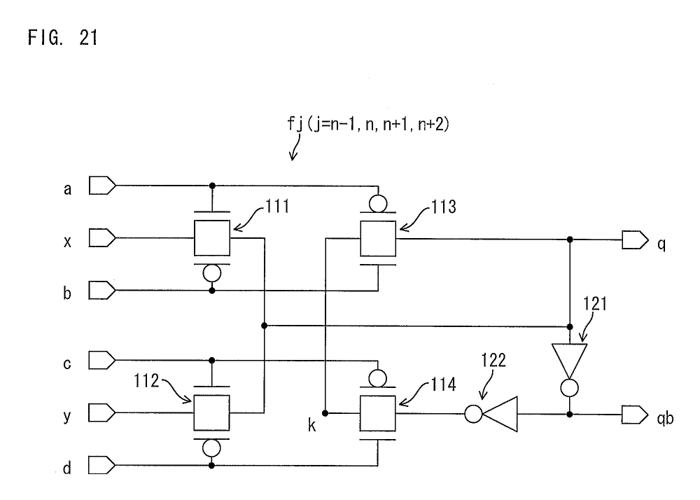

FIG. 21 illustrates how the flip flop fn is specifically configured. As illustrated in FIG. 21, the flip flop fn includes analog switches 111 and 112 and inverters 121 and 122. The terminal b is connected to a P terminal of the analog switch 111. The terminal a is connected to an N terminal of the analog switch 111. The terminal d is connected to a P terminal of the analog switch 112. The terminal c is connected to an N terminal of the analog switch 112. The terminal x is connected to an input terminal of the inverter 121 via the analog switch 111. The terminal y is connected to the input terminal of the inverter 121 via the analog switch 112. The inverter 121 has an output terminal which is connected to an input terminal of the inverter 122. The inverter 122 has an output terminal which is connected to a node k via the analog switch 114. The node k is connected to the input terminal of the inverter 121 via the analog switch 113.

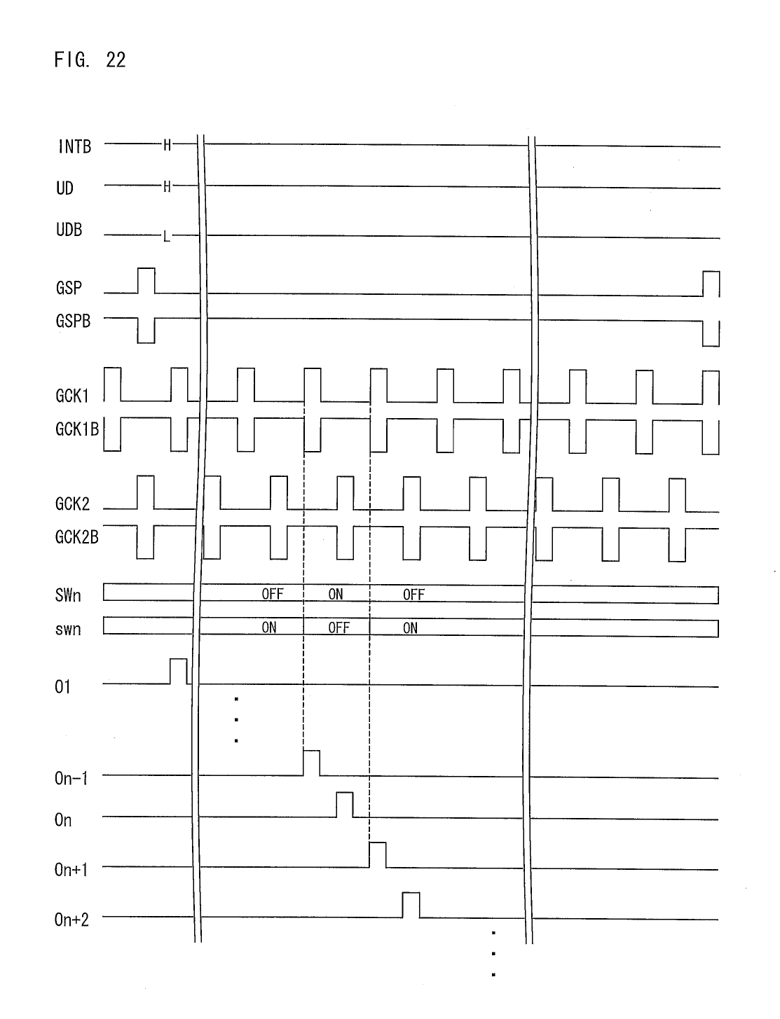

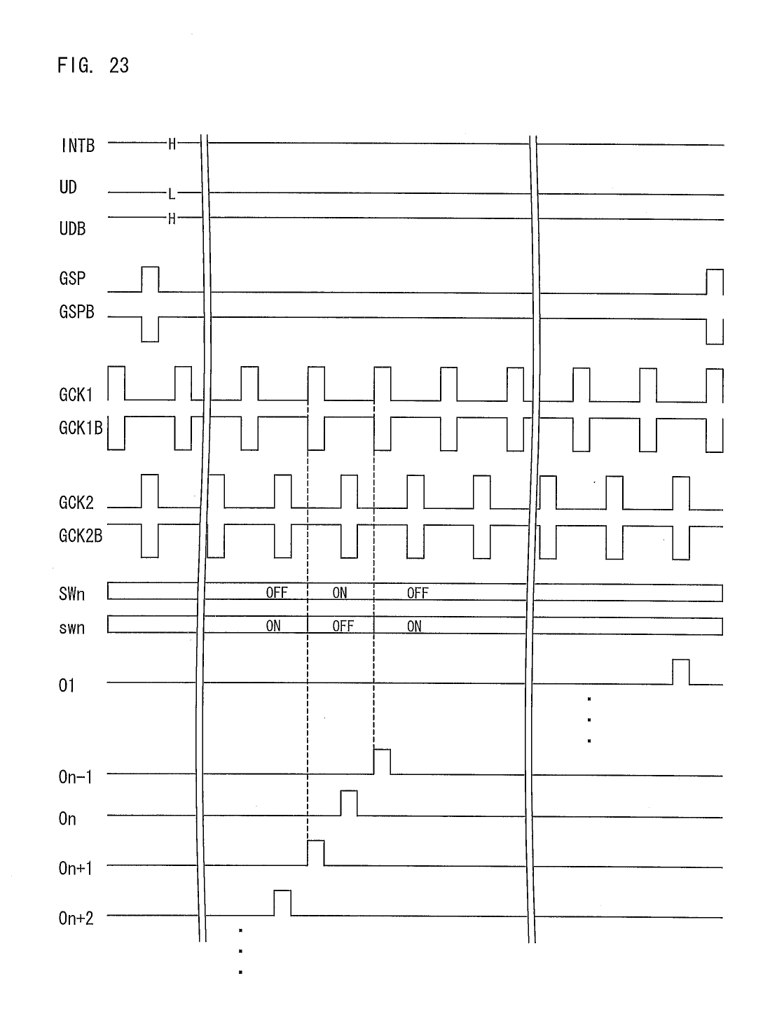

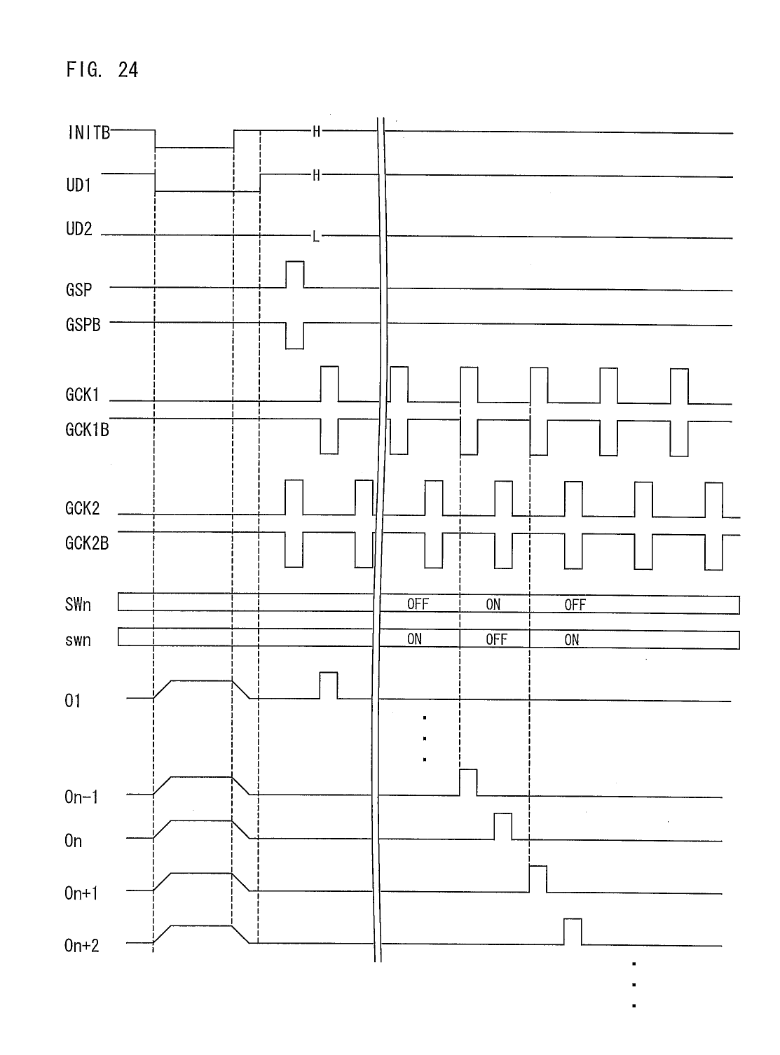

Note that the gate driver 5 of FIG. 20 is driven by a method illustrated in FIG. 22 (forward direction), FIG. 23 (inverse direction), and FIG. 24 (initialization).

### Embodiment 2

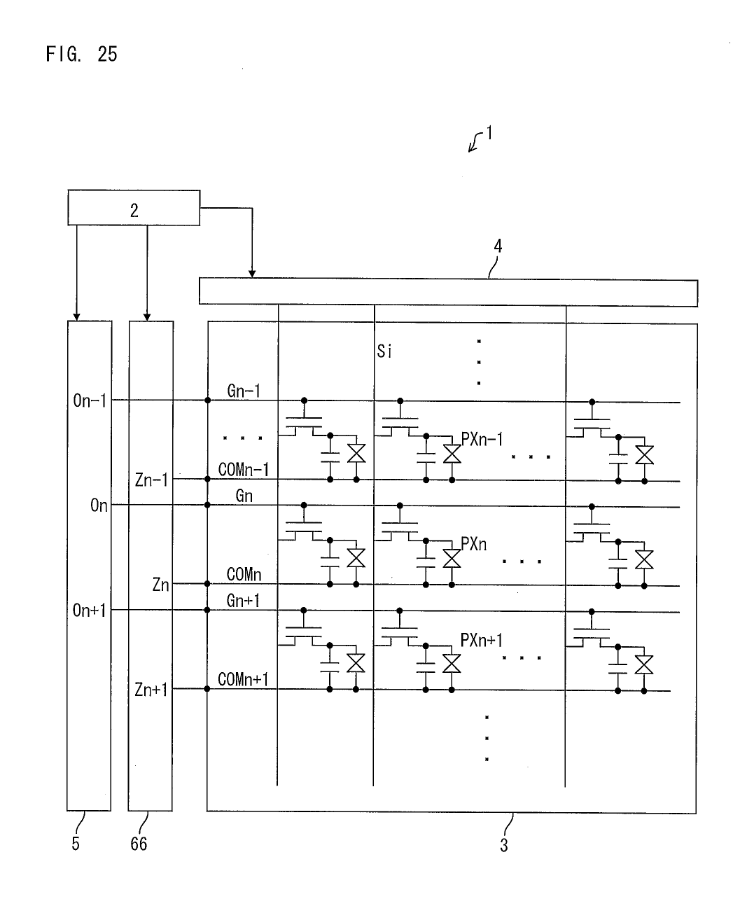

FIG. 25 is a block diagram illustrating a configuration of another liquid crystal display device 1. The liquid crystal display device 1 of FIG. 25 includes a display control circuit 2, a liquid crystal panel 3, a source driver 4, a gate driver 5, and a COM driver 66. The liquid crystal panel 3 includes scanning signal lines (Gn−1, Gn, Gn+1), data signal lines (Si), pixels (PXn−1, PXn, PXn+1), and common electrodes (COMn−1, COMn, COMn+1). A pixel electrode of, for example, the pixel PXn is connected to the scanning signal line Gn and the data signal line Si, via a TFT. Note that the pixel electrode and the common electrode COMn together form a liquid crystal capacitor. The common electrode COMn is connected to an n-th output terminal Zn of the COM driver 66. The scanning signal line Gn is connected to an n-th output terminal On of the gate driver 5. In the configuration, the gate driver 5 (bidirectionally shiftable) outputs, from for example the output terminal On, a scanning signal for driving an n-th scanning signal line. The source driver 4 for driving the data signal lines outputs data signals each of whose polarities is a polarity which is reversed for each n horizontal scanning period(s) (where n is a natural number). For example, the COM driver 66 for driving the common electrodes outputs, from the output terminal Zn, a drive signal for driving an n-th common electrode. The display control circuit 2 controls the source driver 4, the gate driver 5, and the COM driver 66. Note that the gate driver 5 and the COM driver 66 can be provided so that (i) they are disposed on one side of a display section (of the liquid crystal panel) (see FIG. 25) or (ii) the gate driver 5 is provided on one side of a display section (of the liquid crystal panel) and the COM driver 66 is provided on the other side of the display section (i.e., so that the display section of the liquid crystal panel is provided between the gate driver 5 and the COM driver 66). Further alternatively, at least one of the gate driver 5 and the COM driver 66 can be provided so as to be integral (monolithically) with the liquid crystal panel.

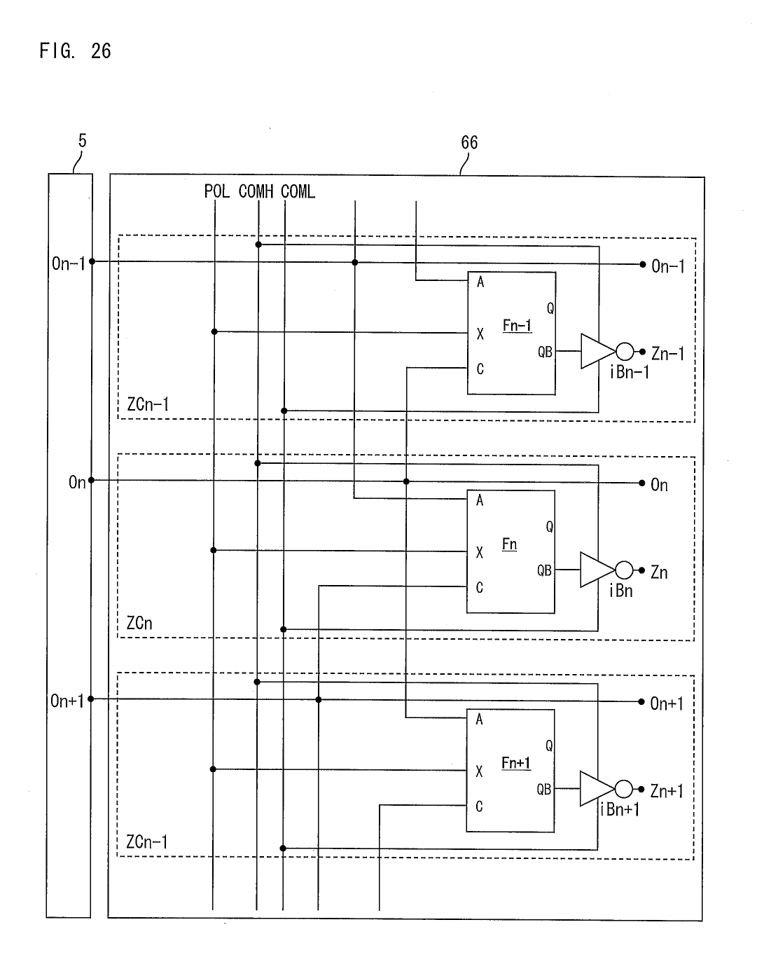

The COM driver 66 of FIG. 25 is configured as illustrated in FIG. 26. Specifically, the COM driver 66 includes: a plurality of unit circuits (ZCn−1, ZCn, ZCn+1). A COM polarity signal line POL is connected to the plurality of unit circuits (ZCn−1, ZCn, ZCn+1). First and second COM electric potential supply line COMH and COML are connected to the plurality of unit circuits (ZCn−1, ZCn, ZCn+1). The unit circuit ZCn−1 is made up of a flip flop Fn−1 and an inverter iBn−1, and has an output terminal Zn−1. The unit circuit ZCn is made up of a flip flop Fn and an inverter iBn, and has an output terminal Zn. The unit circuit ZCn+1 is made up of a flip flop Fn+1 and an inverter iBn+1, and has an output terminal Zn+1. Note that the inverter iBj (j=n−1, n, n+1) has a circuit configuration detailed in FIG. 3 (Note that vH>vL).

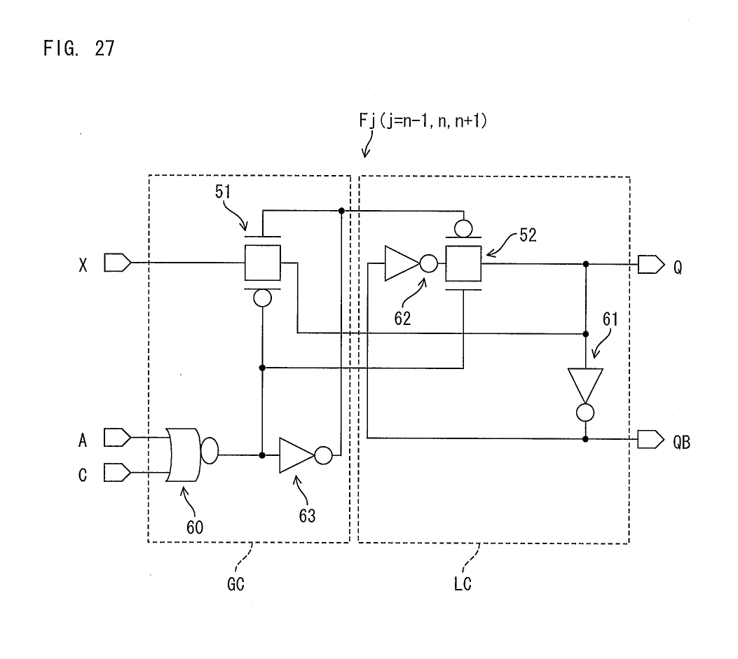

FIG. 27 illustrates how a flip flop Fj (j=n−1, n, n+1) is specifically configured. As illustrated in FIG. 27, the flip flop Fj has three input terminals (A, C, and X) and two output terminals (Q and QB). The flip flop Fj is made up of two analog switches 51 and 52, two inverters 61 and 63, and a single NOR circuit 60. The terminal A is connected to a first input terminal of the NOR circuit 60. The terminal C is connected to a second input terminal of the NOR circuit 60. The terminal X is connected to an input terminal of the inverter 61 via the analog switch 51. The NOR circuit 60 has an output terminal which is connected to (i) a P terminal of the analog switch 51, (ii) an input terminal of the inverter 63, and (iii) an N terminal of the analog switch 52. The inverter 63 has an output terminal which is connected to an N terminal of the analog switch 51 and a P terminal of the analog switch 52. The inverter 61 has an output terminal which is connected to an input terminal of the inverter 62. The inverter 62 has an output terminal which is connected to an input terminal of the inverter 61 via the analog switch 52. The terminal QB is connected to the output terminal of the inverter 61. The NOR circuit 60, the inverter 63, and the analog switch 51 constitute a gate circuit GC. The analog switch 52 and the inverters 61 and 62 constitute a latch circuit LC.

With reference to FIG. 26 again, the following description will discuss a j-th unit circuit ZCj (j=n−1, n, n+1). A j-th output terminal Oj of the gate driver 5 is connected to (i) the terminal C of a (j−1)th flip flop Fn−1 (preceding flip flop) and (ii) the terminal A of a (j+1)th flip flop Fn+1 (subsequent flip flop). The flip flop Fj is arranged such that the terminal A is connected to a (j−1)th output terminal Oj−1 of the gate driver, the terminal C is connected to a (j+1)th output terminal Oj+1 of the gate driver, the terminal X is connected to the COM polarity signal line POL, and the terminal QB is connected to an output terminal Zj of the unit circuit ZCj via the j-th inverter iBj. With the unit circuit ZCj, (i) the electric potential vL (i.e., a low COM electric potential) is outputted from the output terminal Zj in a case where a high level (i.e., non-active) is outputted from the output terminal QB of the flip flop Fj and (ii) the electric potential vH (i.e., a high COM electric potential) is outputted from the output terminal Zj in a case where a low level (i.e., active) is outputted from the output terminal QB.

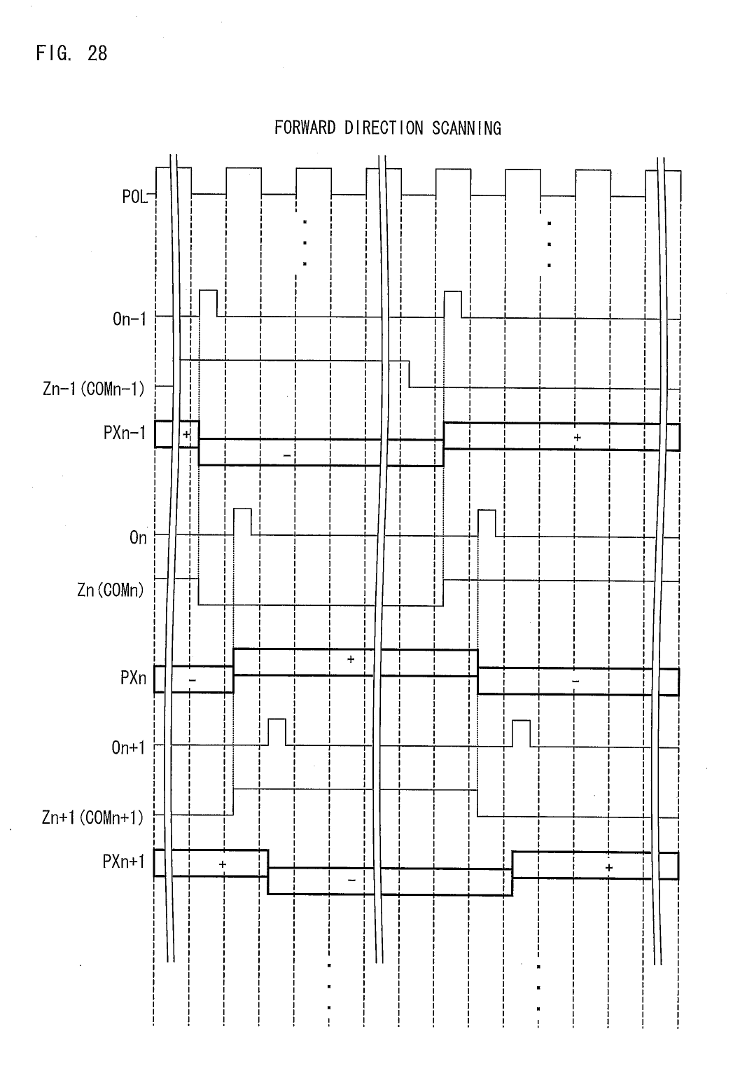

FIG. 28 is a timing chart illustrating a method (forward direction scanning) for driving the liquid crystal display device 1 including the COM driver 66 of FIG. 26. Note that a COM polarity signal, whose polarity is reversed for each horizontal scanning period (1H), is supplied to the COM polarity signal line POL. Note also that the following description will discuss operations while focusing on the n-th output terminal and the n-th unit circuit as respective references.

During the frame F1, in a case where an (n−1)th output terminal On−1 (preceding output terminal) of the gate driver 5 is changed into an active state, a signal potential having a negative polarity is written into a preceding pixel PXn−1. As a result, in the flip flop Fn, the terminal A is set to a high level, the terminal C is set to a low level, and the output terminal of the NOR circuit 60 is set to a high level (i.e., only the analog switch 51 is in an on-state). This causes an inverted signal (“H”) of the COM polarity signal (“L”) to be outputted from the output terminal QB. As such, an electric potential of the output terminal Zn is reversed into the electric potential vL (i.e., the low COM electric potential). In a case where the output terminal On−1 is then changed into a non-active state, in the flip flop Fn, the terminal A is set to a low level, the terminal C is set to the low level, and the output terminal of the NOR circuit 60 is set to the high level (i.e., only the analog switch 52 is in an on-state). This causes the flip flop Fn is changed into a latch state (the high level is remained at the output terminal QB). The electric potential of the output terminal Zn therefore remains to be the electric potential vL.

Next, in a case where the n-th output terminal On of the gate driver 5 is changed into an active state, a signal potential having a positive polarity is written into the pixel PXn. As a result, the flip flop Fn remains to be in the latch state. Since the output terminal Zn (common electrode COMn) has the potential vL, a high voltage is applied to the pixel PXn. The electric potential of the output terminal Un therefore remains to be the electric potential VL. Note that, in the flip flop Fn+1, the terminal A is set to a high level, the terminal C is set to a low level, and the output terminal of the NOR circuit 60 is set to a low level (i.e., only the analog switch 51 is in an on-state). This causes an inverted signal (“L”) of the COM polarity signal (“H”) to be outputted from the output terminal QB. As such, an electric potential of the output terminal Zn+1 is reversed into the electric potential vH (i.e., the high COM electric potential). In a case where the output terminal On is then changed into a non-active state, in the flip flop Fn+1, the terminal A is set to a low level, the terminal C is set to the low level, and the output terminal of the NOR circuit 60 is set to the high level (i.e., only the analog switch 52 is in an on-state). This causes the flip flop Fn to remain in the latch state (the low level is remained at the output terminal QB). The electric potential of the output terminal Zn+1 therefore remains to be the electric potential vH.

Next, in a case where the (n+1)th output terminal On+1 of the gate driver 5 is changed into an active state, a signal potential having a negative polarity is written into the pixel PXn+1. As a result, the flip flop Fn+1 remains to be in the latch state. Since the output terminal Zn+1 (common electrode COMn+1) has the potential vH, a high voltage is applied to the pixel PXn+1. The electric potential of the output terminal Un therefore remains to be the electric potential VL. Note that, in the flip flop Fn, the terminal A is set to a low level, the terminal C is set to a high level, and the output terminal of the NOR circuit 60 is set to a low level (i.e., only the analog switch 51 is in an on-state). This causes an inverted signal (“H”) of the COM polarity signal (“L”) to be outputted from the output terminal QB. As such, an electric potential of the output terminal Zn remains to be the electric potential vL (i.e., the low COM electric potential). In a case where the output terminal On+1 is then changed into a non-active state, in the flip flop Fn, the terminal A is set to a low level, the terminal C is set to the low level, and the output terminal of the NOR circuit 60 is set to the high level (i.e., only the analog switch 52 is in an on-state). This causes the flip flop Fn to remain in the latch state (the low level is remained at the output terminal QB). The electric potential of the output terminal Zn therefore remains to be the electric potential vL.

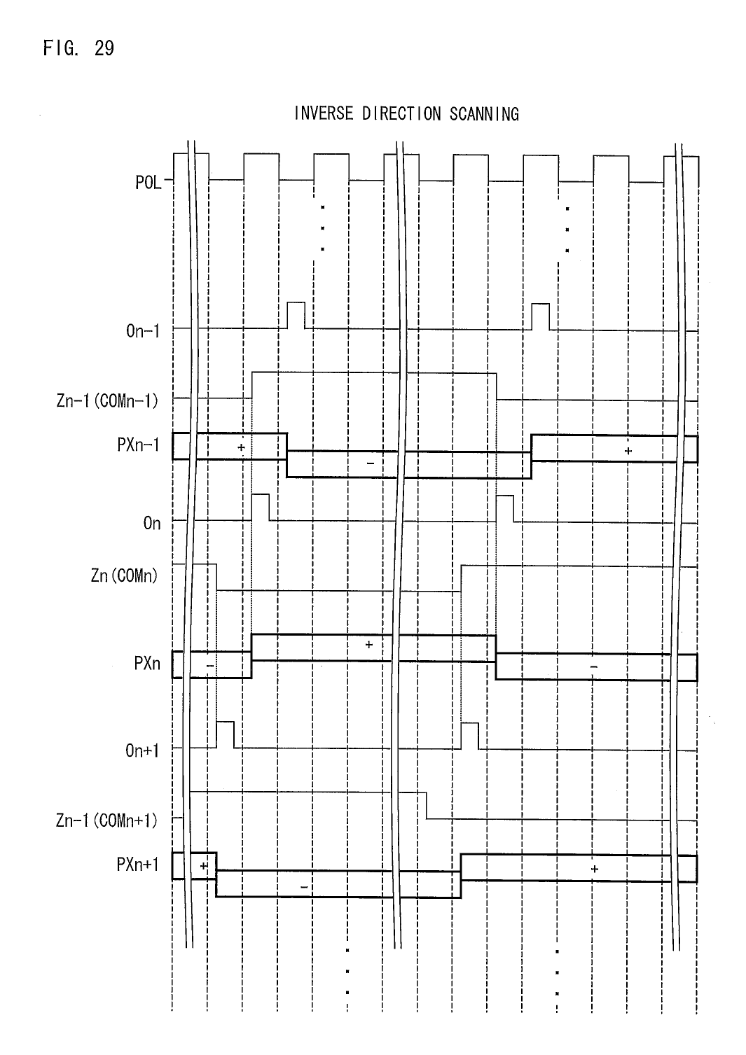

A flip flop of the COM driver 66 (see FIG. 26) thus latches (i) an inverted signal of a COM polarity signal generated when a preceding output terminal (i.e., an immediately preceding output terminal) of the gate driver 5 is changed into an active state and then (ii) an inverted signal of a COM polarity signal generated when a next output terminal (i.e., an immediately subsequent output terminal) of the gate driver 5 is changed into an active state. Since the COM polarity signal is subjected to 1H polarity reversal, the polarity of an inverted signal of a COM polarity signal generated when the preceding output terminal of the gate driver 5 is changed into an active state is identical to the polarity of an inverted signal of a COM polarity signal generated when the subsequent output terminal is changed into an active state. It is therefore possible to carry out COM driving with a simple circuit configuration as illustrated in FIG. 26. Note that the liquid crystal display device 1 including the COM driver 66 carries out inverse direction scanning as illustrated in FIG. 29. According to the timing charts of FIGS. 28 and 29, a source polarity signal to be supplied to the source driver 4 has a phase which is identical to a phase of the COM polarity signal to be supplied to the COM polarity signal line POL. It is therefore possible to use a single polarity signal both as both the source polarity signal and the COM polarity signal.

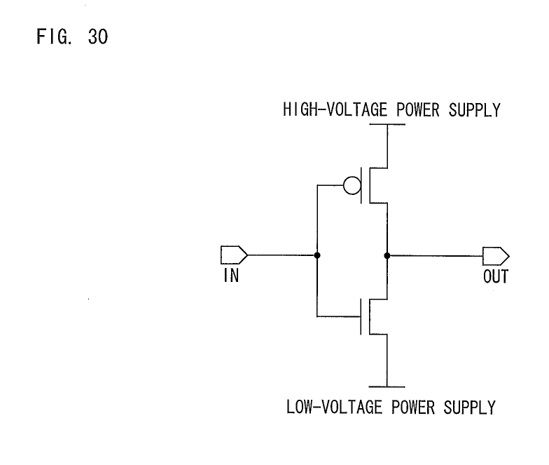

Note that a circuit such as a circuit illustrated in FIG. 30, for example, can be employed as an inverter for the embodiments. Specifically, the circuit is arranged such that (i) a first conducting terminal of a P channel transistor, a first conducting terminal of an N channel transistor, and an output terminal OUT are connected to one another, (ii) the P channel transistor has a second conducting terminal which is connected to a high-voltage power supply, whereas the N channel transistor has a second conducting terminal which is connected to a low-voltage power supply, and (iii) a control terminal of the P channel transistor, a control terminal of the N channel transistor, and an input terminal IN are connected to one another.

The signal generator circuit of the present invention may be arranged such that the electric conductor is a retention capacitor line with which the pixel electrode forms a retention capacitor; and the drive signal causes an electric potential of the retention capacitor line to fluctuate after the data signal is supplied to the pixel electrode.

The signal generator circuit of the present invention may be arranged such that the gate circuit includes a first switch and a second switch; and in regard to the one flip flop, (a) the first switch has a control terminal via which the signal synchronized with the scanning signal of the preceding stage is supplied, (b) the second switch has a control terminal via which the signal synchronized with the scanning signal of the subsequent stage is supplied, and (c) the latch circuit receives (i) the polarity signal via the first switch and (ii) the polarity signal or another polarity signal whose polarity is reversed for each n horizontal scanning period(s), via the second switch. The signal generator circuit of the present invention may be arranged such that the polarity signal and the another polarity signal have respective phases which are opposite to each other.

The signal generator circuit of the present invention may be arranged such that the signal generator circuit carries out initialization for causing respective outputs of the flip flops to become active; and a phase relation between the polarity signal and the another polarity signal during the initialization is different from a phase relation between the polarity signal and the another polarity signal during normal driving.

The signal generator circuit of the present invention may be arranged such that the electric conductor is a common electrode with which the pixel electrode forms a liquid crystal capacitor; and the drive signal causes an electric potential of the common electrode to fluctuate before the data signal is supplied to the pixel electrode.

The signal generator circuit of the present invention may be arranged such that the gate circuit includes a switch and a logic circuit; and in regard to the one flip flop, (a) the logic circuit receives the signal synchronized with the scanning signal of the preceding stage, and the signal synchronized with the scanning signal of the subsequent stage, and (b) the latch circuit receives the polarity signal via the switch.

The signal generator circuit of the present invention may be arranged such that an identical signal is used both as (i) a signal which defines polarity reversal of the data signal and (ii) the polarity signal.

The signal generator circuit of the present invention may be arranged such that the scanning signal line driving circuit is capable of forward direction scanning and inverse direction scanning.

The signal generator circuit of the present invention may be arranged such that in regard to the one of the stages, (i) a polarity of the polarity signal when a scanning signal of the one of the stages is in active during the forward direction scanning and (ii) a polarity of the polarity signal when a scanning signal of the one of the stages is in active during the inverse forward direction scanning are different from each other.

A liquid crystal display device of the present invention includes the signal generator circuit.

The liquid crystal display device of the present invention may be arranged such that the scanning signal line driving circuit is provided on one side of a display section; and the signal generator circuit is provided on the other side of the display section.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The signal generator circuit of the present invention is suitable for a liquid crystal display device.

### REFERENCE SIGNS LIST

1 liquid crystal display device
4 source driver (data signal line driving circuit)
5 gate driver (scanning signal line driving circuit)
6 CS driver (signal generator circuit)
66 COM driver (signal generator circuit)
Fn, fn flip flop
On output terminal of a gate driver
Un output terminal of a CS driver
Zn output terminal of a COM driver
POL CS polarity signal line
POL1 first CS (COM) polarity signal line
POL2 second CS (COM) polarity signal line
SP source polarity signal
INITB inversion initialization signal
UD1 shift direction signal 1
UD2 shift direction signal 2

1. A signal generator circuit for use in a display device,
the display device including (a) a pixel having a pixel electrode, (b) an electric conductor with which the pixel electrode forms a capacitor, (c) a data signal line driving circuit which outputs a data signal whose polarity is reversed for each n horizontal scanning period(s), where n is a natural number, and (d) a scanning signal line driving circuit which outputs scanning signals corresponding to respective stages, said signal generator circuit generating a drive signal supplied to the electric conductor, wherein:
said signal generator circuit comprises flip flops corresponding to the respective stages, each flip flop including a gate circuit and a latch circuit; and
in regard to one flip flop corresponding to one of the stages, (i) the gate circuit is supplied with a signal synchronized with a scanning signal corresponding to a preceding stage of the one of the stages, and a signal synchronized with a scanning signal corresponding to a subsequent stage of the one of the stages, (ii) the latch circuit is supplied with a polarity signal whose polarity is reversed for each n horizontal scanning period(s) via the gate circuit, and (iii) the drive signal of the one of the stages is generated in accordance with an output of the one flip flop.

2. The signal generator circuit according to claim 1,
wherein:
the electric conductor is a retention capacitor line with which the pixel electrode forms a retention capacitor; and
the drive signal causes an electric potential of the retention capacitor line to fluctuate after the data signal is supplied to the pixel electrode.

3. The signal generator circuit according to claim 2,
wherein:
the gate circuit includes a first switch and a second switch; and
in regard to the one flip flop, (a) the first switch has a control terminal via which the signal synchronized with the scanning signal of the preceding stage is supplied, (b) the second switch has a control terminal via which the signal synchronized with the scanning signal of the subsequent stage is supplied, and (c) the latch circuit receives (i) the polarity signal via the first switch and (ii) the polarity signal or another polarity signal whose polarity is reversed for each n horizontal scanning period(s), via the second switch.

4. The signal generator circuit according to claim 3,
wherein:
the polarity signal and the another polarity signal have respective phases which are opposite to each other.

5. The signal generator circuit according to claim 3,
wherein:
the signal generator circuit carries out initialization for causing respective outputs of the flip flops to become active; and
a phase relation between the polarity signal and the another polarity signal during the initialization is different from a phase relation between the polarity signal and the another polarity signal during normal driving.

6. The signal generator circuit according to claim 1,
wherein:
the electric conductor is a common electrode with which the pixel electrode forms a liquid crystal capacitor; and
the drive signal causes an electric potential of the common electrode to fluctuate before the data signal is supplied to the pixel electrode.

7. The signal generator circuit according to claim 6,
wherein:
the gate circuit includes a switch and a logic circuit; and
in regard to the one flip flop, (a) the logic circuit receives the signal synchronized with the scanning signal of the preceding stage, and the signal synchronized with the scanning signal of the subsequent stage, and (b) the latch circuit receives the polarity signal via the switch.

8. The signal generator circuit according to claim 1,
wherein:
an identical signal is used both as (i) a signal which defines polarity reversal of the data signal and (ii) the polarity signal.

9. The signal generator circuit according to claim 1,
wherein:
the scanning signal line driving circuit is capable of forward direction scanning and inverse direction scanning.

10. The signal generator circuit according to claim 9,
wherein:
in regard to the one of the stages, (i) a polarity of the polarity signal when a scanning signal of the one of the stages is in active during the forward direction scanning and (ii) a polarity of the polarity signal when a scanning signal of the one of the stages is in active during the inverse forward direction scanning are different from each other.

11. A liquid crystal display device comprising
a signal generator circuit recited in claim 1.

12. The liquid crystal display device according to claim 11,
wherein:
the scanning signal line driving circuit is provided on one side of a display section; and
the signal generator circuit is provided on the other side of the display section.
